(19) United States
(12) Patent Application Publication
(10) Pub. No.: US 2025/0383429 A1
(43) Pub. Date: Dec. 18, 2025

(54) LIGHT RECEIVING DEVICE, INFORMATION PROCESSING DEVICE, DISTANCE MEASURING DEVICE, AND INFORMATION PROCESSING METHOD

(71) Applicant: SONY SEMICONDUCTOR SOLUTIONS CORPORATION, KANAGAWA (JP)

(72) Inventors: Takashi MIYAMOTO, KANAGAWA (JP); Yasunori TSUKUDA, KANAGAWA (JP)

(21) Appl. No.: 18/878,153

(22) PCT Filed: Jun. 13, 2023
(86) PCT No.: PCT/JP2023/021932

§ 371 Date: Dec. 23, 2024

(30) Foreign Application Priority Data
Jun. 29, 2022 (JP) 2022-104581

(51) Int. Cl. G01S 7/4865; G01S 17/10

(52) U.S. Cl. CPC G01S 7/4865; G01S 17/10

(57) ABSTRACT

A light receiving device according to the present technology includes: a light receiving unit that receives reflected light in which light emitted from a light emitting unit according to a light emission instruction issued on the basis of a predetermined processing cycle is reflected by a subject; and a calculation unit that calculates information regarding a distance to the subject according to a difference between a light emission timing of the light emitting unit and a light reception timing of the light receiving unit, in which the light emission instruction is issued at a timing delayed by a shift period with respect to a reference timing in each cycle of the predetermined processing cycle for each medium period including a plurality of small periods each including one time of light emission, and a ratio of the shift period to each of the small periods is changed for each large period including a plurality of the medium periods.

### TECHNICAL FIELD

The present technology relates to a light receiving device, an information processing device, a distance measuring device, and an information processing method for measuring distance information using a time-of-flight method (ToF method).

### BACKGROUND ART

In the distance measurement by a time of flight (ToF) method, pulse-like light (pulsed light) is emitted to a subject to be measured at a predetermined cycle, and reflected light from the subject is detected, thereby measuring a round-trip time of light and calculating a distance to the subject.

In a case where there is another light source that repeats light emission in synchronization with the irradiation cycle of the pulsed light, the distance to the subject may be erroneously measured by detecting light emitted from the another light source.

In order to solve such a problem, Patent Document 1 described below discloses a configuration for determining whether detected light is normally reflected light or interference light by inserting an offset having a random time length for each irradiation of a predetermined cycle.

### CITATION LIST

### Patent Document

Patent Document 1: Japanese Patent Application Laid-Open No. 2019-056567

### SUMMARY OF THE INVENTION

### Problems to be Solved by the Invention

However, since the method of Patent Document 1 inserts a random offset every time pulsed light is emitted, there is a problem that the processing load of the circuit is large and the power consumption is also large.

The present technology has been made in view of such a problem, and an object thereof is to propose a configuration for calculating an appropriate distance while suppressing an increase in processing load.

### Solutions to Problems

A light receiving device according to the present technology includes: a light receiving unit that receives reflected light in which light emitted from a light emitting unit according to a light emission instruction issued on the basis of a predetermined processing cycle is reflected by a subject; and a calculation unit that calculates information regarding a distance to the subject according to a difference between a light emission timing of the light emitting unit and a light reception timing of the light receiving unit, in which the light emission instruction is issued at a timing delayed by a shift period with respect to a reference timing in each cycle of the predetermined processing cycle for each medium period including a plurality of small periods each including one time of light emission, and a ratio of the shift period to each of the small periods is changed for each large period including a plurality of the medium periods.

By providing the shift period for each medium period in which the small periods continue, the periodicity of the light emission timing is lost.

An information processing device according to the present technology described above includes another light source detection processing unit that detects light emitted from another light source other than a light emitting unit on the basis of information regarding a distance to a subject calculated according to a difference between a light emission timing of light emitted from the light emitting unit by a light emission instruction issued on the basis of a predetermined processing cycle and a light reception timing of receiving reflected light obtained by reflecting the light on the subject, in which the light emission instruction is issued at a timing delayed by a shift period with respect to a reference timing in each cycle of the predetermined processing cycle for each medium period including a plurality of small periods each including one time of light emission, and a ratio of the shift period to each of the small periods is changed for each large period including a plurality of the medium periods.

A distance measuring device according to the present technology described above includes: a light receiving unit that receives reflected light in which light emitted from a light emitting unit according to a light emission instruction issued on the basis of a predetermined processing cycle is reflected by a subject; and a calculation unit that calculates distance data to the subject according to a difference between a light emission timing of the light emitting unit and a light reception timing of the light receiving unit, in which the light emission instruction is issued at a timing delayed by a shift period with respect to a reference timing in each cycle of the predetermined processing cycle for each medium period including a plurality of small periods each including one time of light emission, and a ratio of the shift period to each of the small periods is changed for each large period including a plurality of the medium periods.

An information processing method executed by an information processing device according to the present technology described above, the information processing method including: for light that is emitted from a light emitting unit according to a light emission instruction issued on the basis of a predetermined processing cycle and in which information regarding a distance to a subject is calculated according to a difference between a light reception timing by the light receiving unit that receives reflected light obtained by the light being reflected by the subject and a light emission timing of the light emitting unit, issuing the light emission instruction at a timing delayed by a shift period with respect to a reference timing in each cycle of the predetermined processing cycle for each medium period including a plurality of small periods each including one time of light emission; and changing a ratio of the shift period to each of the small periods for each large period including a plurality of the medium periods.

With such an information processing device, a distance measuring device, and an information processing method, it is also possible to obtain an action similar to that of the light receiving device according to the present technology described above.

### BRIEF DESCRIPTION OF DRAWINGS

FIG. 1 is a block diagram illustrating a configuration example of a distance measuring system according to a first embodiment of the present technology.

FIG. 2 is a block diagram illustrating an example of a time management unit.

FIG. 3 is a diagram illustrating an example of a relationship among a light emission timing signal, light reception intensity, and a counter value.

FIG. 4 is a diagram illustrating an example in which a small period includes only a light receiving period.

FIG. 5 is a diagram illustrating an example in which a small period includes a light receiving period and a non-light receiving period.

FIG. 6 is a diagram for explaining a relationship between a small period and a shift period.

FIG. 7 is a block diagram illustrating an example of a light emitting unit.

FIG. 8 is a block diagram illustrating an example of a ToF sensor.

FIG. 9 is a block diagram illustrating an example of a distance calculation unit.

FIG. 10 is an example of a histogram generated on the basis of unit distance data of each of a first medium period and a second medium period.

FIG. 11 is an explanatory diagram for detecting interference light.

FIG. 12 is an explanatory diagram for calculation of accurate distance data.

FIG. 13 is a diagram illustrating a configuration example of a large period in the first embodiment.

FIG. 14 is a diagram illustrating an example of a state in which information regarding a distance is stored in a payload area of packet data conforming to MIPI.

FIG. 15 is a diagram illustrating another example of packet data conforming to MIPI.

FIG. 16 is a diagram illustrating another example of packet data conforming to MIPI, which is an example using a virtual channel.

FIG. 17 is a diagram illustrating still another example of the packet data conforming to MIPI, and an example in which both the data for the first medium period and the data for the second medium period are stored in the payload area.

FIG. 18 is a diagram illustrating another example of packet data conforming to MIPI and an example in which another light source information is included.

FIG. 19 is a flowchart illustrating an example of processing executed by a distance measuring system.

FIG. 20 is a flowchart illustrating an example of measurement in a medium period.

FIG. 21 is a flowchart illustrating an example of processing executed in a distance calculation unit.

FIG. 22 is a block diagram illustrating an example of a light emitting unit in a second embodiment.

FIG. 23 is a block diagram illustrating an example of a ToF sensor according to a second embodiment.

FIG. 24 is a block diagram illustrating an example of a distance measuring system according to a third embodiment.

FIG. 25 is a diagram illustrating a configuration example of a large period in Modification 2 regarding a shift period.

FIG. 26 is a diagram illustrating another example of a configuration of the large period in Modification 2 regarding the shift period.

FIG. 27 is a diagram illustrating still another example of the configuration of the large period in Modification 2 regarding the shift period.

FIG. 28 is a diagram illustrating another example of the configuration of the large period in Modification 2 regarding the shift period.

FIG. 29 is a diagram illustrating a configuration example of the large period in Modification 2 regarding the shift period, and is a diagram illustrating an example in which an adjustment period is not provided.

FIG. 30 is a diagram illustrating a configuration example of a large period in Modification 3 regarding the shift period.

FIG. 31 is a diagram illustrating a configuration example of a large period in Modification 4 regarding the shift period.

FIG. 32 is a diagram illustrating a configuration example of a large period in Modification 5 regarding the shift period.

FIG. 33 is a diagram illustrating a configuration example of a large period in Modification 6 regarding the shift period.

FIG. 34 is a diagram illustrating a configuration example of a large period in Modification 7 regarding the shift period.

FIG. 35 is a diagram illustrating another example of a configuration example of the large period in Modification 7 regarding the shift period.

FIG. 36 is a diagram illustrating a configuration example of a large period in Modification 8 regarding the shift period.

FIG. 37 is a diagram illustrating a configuration example of a large period in Modification 9 regarding the shift period.

FIG. 38 is a diagram illustrating another example of the configuration example of the large period in Modification 9 regarding the shift period.

FIG. 39 is a diagram for explaining an example of a mode of selecting a length of the shift period.

FIG. 40 is a diagram illustrating a configuration example of the large period in which no shift period is provided.

FIG. 41 is a diagram illustrating another example of a configuration example of the large period in which no shift period is provided.

### MODE FOR CARRYING OUT THE INVENTION

Hereinafter, embodiments according to the present technology will be described in the following order with reference to the accompanying drawings.
<1. First embodiment>
<1-1. Configuration of distance measuring system>
<1-2. Data transmission>
<1-3. Processing flow>
<2. Second embodiment>
<3. Third embodiment>
<4. Modification of shift period>
<4-1. Modification 1>
<4-2. Modification 2>
<4-3. Modification 3>
<4-4. Modification 4>
<4-5. Modification 5>
<4-6. Modification 6>
<4-7. Modification 7>
<4-8. Modification 8>
<4-9. Modification 9>
<4-10. Modification 10>
<5. Other modifications>
<6. Summary>
<7. Present technology>

### 1. First Embodiment

### <1-1. Configuration of Distance Measuring System>

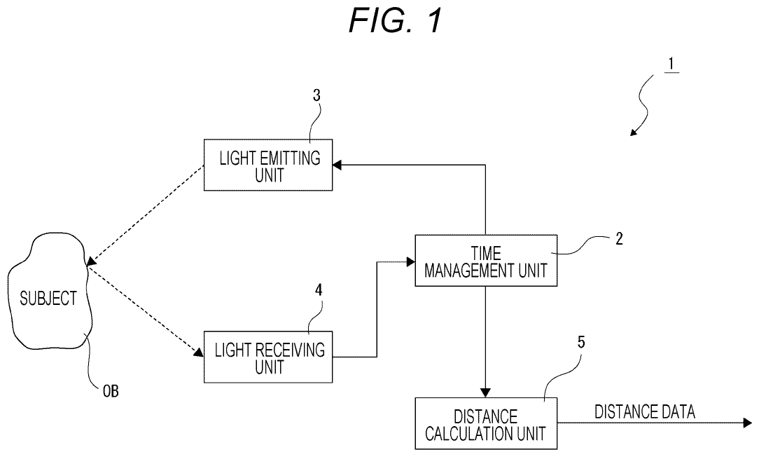

An outline of a configuration of a distance measuring system 1 of the present technology will be described with reference to FIG. 1. Note that the following configuration is obtained by applying the present technology to direct ToF (dToF), but the present technology is not limited thereto and can be applied to indirect ToF (iToF).

The distance measuring system 1 measures a distance between a subject OB as a distance measuring object and the distance measuring system 1 by calculating a difference time between a timing at which the subject OB is irradiated with light and a timing at which the reflected light is received.

The distance measuring system 1 includes a time management unit 2, a light emitting unit 3, a light receiving unit 4, and a distance calculation unit 5.

The time management unit 2 determines a light emission timing of a light emitting element included in the light emitting unit 3 and issues a light emission instruction to the light emitting unit 3.

The light emitting unit 3 emits light in accordance with a light emission timing signal supplied at a predetermined timing based on the light emission instruction issued from the time management unit 2.

The light receiving unit 4 receives reflected light in which light emitted from the light emitting unit 3 is reflected by the subject OB, and outputs a light reception pulse signal to the time management unit 2.

The time management unit 2 receives the pulse-like light reception signal output from the light receiving unit 4, and outputs time information regarding the light emission timing and time information regarding the light reception timing to the distance calculation unit 5.

The distance calculation unit 5 calculates distance data between the distance measuring system 1 and the subject OB using the time information regarding the light emission timing and the time information regarding the light reception timing output from the time management unit 2.

Intermediate data is used in the calculation of the distance data in the distance calculation unit 5.

Here, the intermediate data will be described. In the present embodiment, one unit distance data obtained as a result of unit distance measurement in which one light emission and one light reception are paired is treated as intermediate data. Then, the distance calculation unit 5 calculates one distance data on the basis of a plurality of unit distance data obtained as a result of a plurality of the unit distance measurements.

Specifically, a histogram is generated using a plurality of pieces of intermediate data (unit distance data) obtained as a result of the plurality of times of unit distance measurement. Then, the distance calculation unit 5 outputs a distance having the highest frequency in the histogram as distance data obtained in a series of distance measurements.

As a result, it is possible to prevent erroneous distance data from being output on the basis of light from another light source that is accidentally received.

Note that the histogram data may be treated as intermediate data.

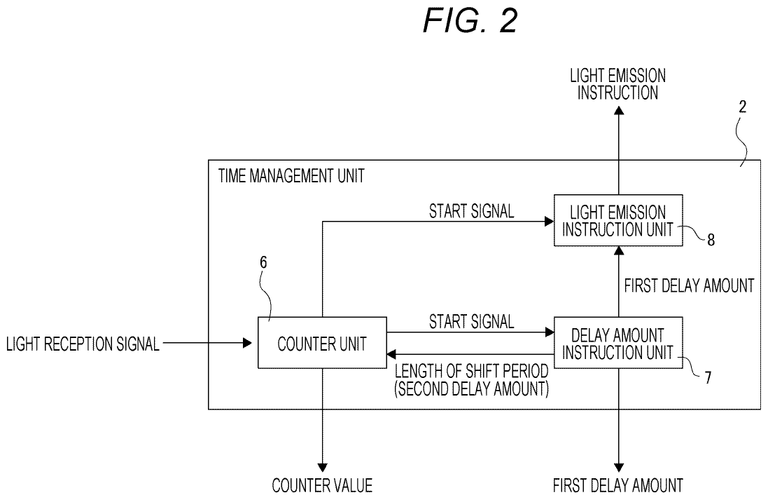

An example of a specific configuration of the time management unit 2 is illustrated in FIG. 2.

The time management unit 2 includes a counter unit 6, a delay amount instruction unit 7, and a light emission instruction unit 8.

The counter unit 6 includes, for example, a counter that counts up from 0 to a predetermined number every predetermined time, and outputs a counter value at timing when a light reception signal is received. Furthermore, the counter of the counter unit 6 can be reset to an initial value (0) by a reset command.

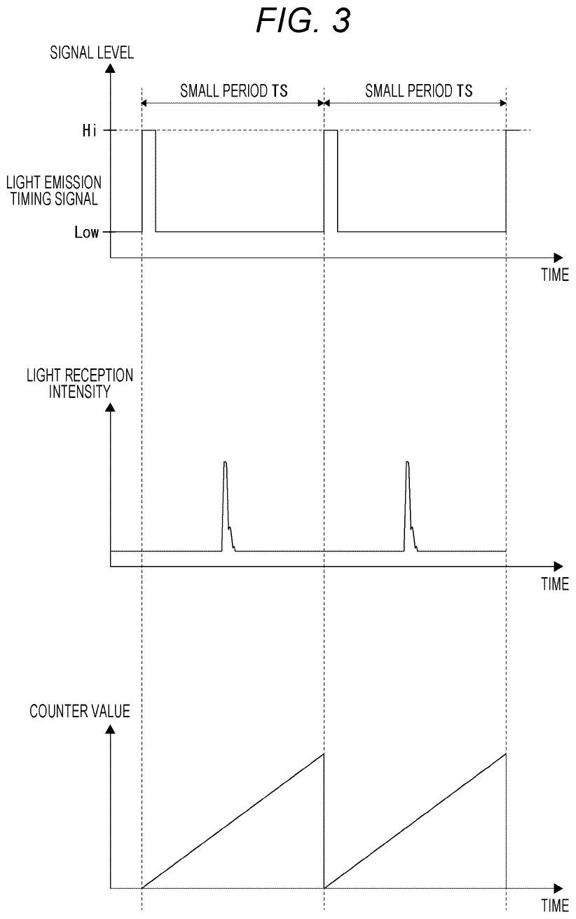

FIG. 3 illustrates an example of a relationship among a light emission timing signal, a light reception intensity in the light receiving unit 4, and a counter value of the counter managed by the counter unit 6.

As illustrated in FIG. 3, after a time according to a distance to the subject OB has elapsed from the pulse-like light emission timing signal, the light receiving unit 4 detects light reception based on pulse-like reflected light. Then, the difference time can be specified by the increment of the counter value.

In the present embodiment, a period including one unit distance measurement described above is defined as a “small period TS”. In the small period TS, the light emission of the light emitting unit 3 and the light reception of the light receiving unit 4 can be performed once. Note that, since there is no guarantee that the reflected light emitted from the light emitting unit 3 and reflected by the subject OB can be reliably detected by the light receiving unit 4, there is a case where the light reception by the light receiving unit 4 is not detected in the small period TS and only the light emission of the light emitting unit 3 is performed.

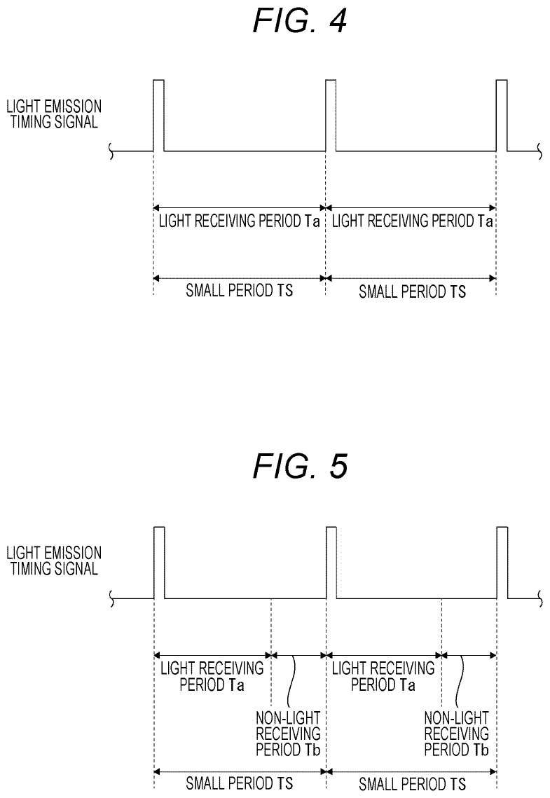

Note that the period during which the unit distance measurement is performed is a period during which reflected light with respect to the subject OB is detected, and can be regarded as a “light receiving period Ta”. The small period TS may include only the light receiving period Ta (see FIG. 4) or may include the light receiving period Ta and a non-light receiving period Tb (see FIG. 5).

Note that, depending on the configuration of the distance measuring system 1, there is a possibility that reflected light for the subject OB is detected (received) even in the non-light receiving period Tb. In this case, for example, the light receiving period Ta may be regarded as a period in which the unit distance measurement is substantially valid, and the non-light receiving period Tb may be regarded as a period in which the unit distance measurement is substantially invalid.

The light receiving period Ta is a period for waiting for reception of reflected light so that the distance to the subject OB located in a distance measurement target range can be measured. A length of the light receiving period Ta is uniquely determined by the distance measurement target range.

The non-light receiving period Tb is a time other than the light receiving period Ta in the small period TS, and may be provided, for example, before light emission or after the light receiving period Ta.

An example in which the small period TS includes both the light receiving period Ta and the non-light receiving period Tb will be described again.

The counter unit 6 illustrated in FIG. 2 supplies a start signal indicating a start timing of the small period TS to the delay amount instruction unit 7 and the light emission instruction unit 8. Note that the start timing of the small period TS may be the same as the light emission timing or may be before the light emission timing. That is, the light emission timing may arrive after a predetermined time from the start timing of the small period TS.

The counter unit 6 resets the counter value to 0 in accordance with the start timing of the small period TS.

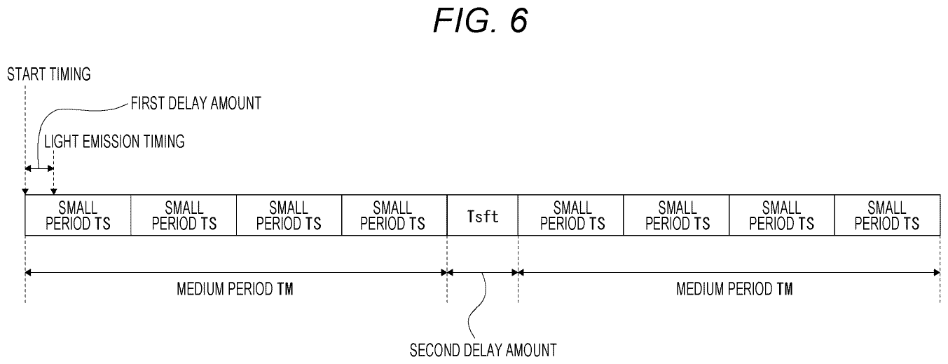

The delay amount instruction unit 7 determines a delay amount (first delay amount) from the start timing on the basis of the start signal supplied from the counter unit 6 and instructs the light emission instruction unit 8 on the delay amount. As a result, as illustrated in FIG. 6, light emission is performed at a timing delayed by the first delay amount from the start timing of the small period TS. Of course, by setting the first delay amount to “0”, light emission may be performed substantially at the same time as the start timing of the small period TS.

Furthermore, the delay amount instruction unit 7 determines a delay amount (second delay amount) for delaying the start timing of the small period TS and supplies the delay amount to the counter unit 6. The second delay amount is inserted between a part of the small period TS and the small period TS. A period between the small periods defined by the delay amount is referred to as a “shift period Tsft”.

The counter unit 6 resets the counter value to zero according to a length (second delay amount) of the shift period Tsft supplied from the delay amount instruction unit 7. Note that the delay amount instruction unit 7 may issue a reset command to the counter unit 6 after waiting for the length of the shift period Tsft.

The movement of the counter value of the counter during the standby in the shift period Tsft may be continuously counted up from the last small period TS, and may be reset at the end of the standby in the shift period Tsft, that is, at the start of the next small period TS, or may be reset once with the end of the last small period TS, and may be reset again at the end of the standby in the shift period Tsft.

Furthermore, the shift period Tsft is not inserted between all the small periods TS, but is inserted for each of the plurality of small periods TS. That is, the shift period Tsft is a period provided to prevent the small period TS from being excessively continuous at a constant interval without an interval, and is a period provided to periodically shift the start timing of the small period TS as illustrated in FIG. 6.

Furthermore, by providing the shift period Tsft periodically (or irregularly), the timing of light emission performed for each small period TS is shifted periodically (or irregularly). Detection of interference light to be described later can be realized by regularly or irregularly shifting the light emission timing.

Note that a portion in which the small periods TS continue is referred to as a medium period TM. The medium period TM is a period constituting a large period TL to be described later, and specifically, the large period TL includes a plurality of the medium periods TM. The large period TL is a period for calculating one final distance data on the basis of a plurality of unit distance data for the subject OB, and is a frame period.

However, the large period TL may be a subframe period (subframe cycle), a line period (line cycle), or the like constituting a frame period (frame cycle), and the large period TL may be a cycle in which at least one of a physical irradiation position and an irradiation range of laser light by a light emitting element 11 is changed. In the following description, an example in which the large period TL is a frame period will be described.

The start period of the small period TS is delayed by the shift period Tsft for each medium period TM. Therefore, the light emission instruction (light emission timing) is also delayed by the shift period Tsft for each medium period TM.

The light emission instruction unit 8 supplies a light emission instruction according to the start signal supplied from the counter unit 6 and the first delay amount supplied from the delay amount instruction unit 7 to the light emitting unit 3.

As described above, the time management unit 2 manages various delay amounts with respect to the light emission timing, thereby supplying the light emission instruction according to the delay amount to the light emitting unit 3 and outputting the counter value according to the light reception signal to the distance calculation unit 5.

Each unit illustrated in FIG. 2 included in the time management unit 2 may be provided as a portion (for example, a single information processing device) different from the light emitting unit 3 and the light receiving unit 4 as illustrated in FIG. 1, but each unit included in the time management unit 2 may be included in any of the light emitting unit 3, the light receiving unit 4, and the distance calculation unit 5. In the present embodiment, an example in which each unit as the time management unit 2 is included in the light receiving unit 4 will be described.

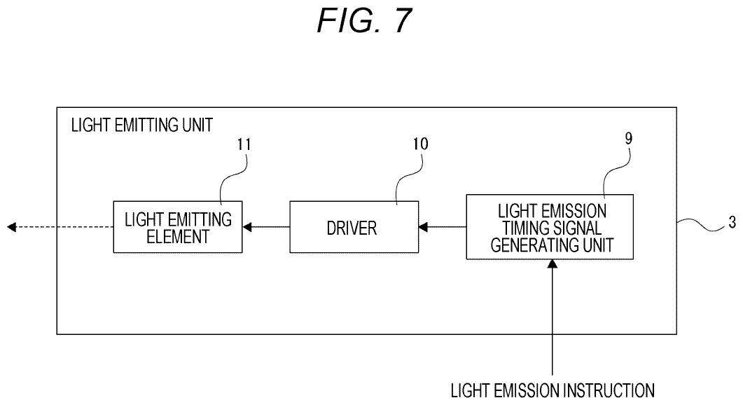

First, a specific configuration of the light emitting unit 3 is illustrated in FIG. 7.

The light emitting unit 3 includes a light emission timing signal generating unit 9, a driver 10, and the light emitting element 11.

The light emission timing signal generating unit 9 generates a pulse-like light emission timing signal according to the light emission instruction supplied from the light emission instruction unit 8, and supplies the pulse-like light emission timing signal to the driver 10. The light emission timing signal is obtained by adding the first delay amount and the second delay amount (the length of the shift period Tsft).

The driver 10 drives the light emitting element 11 in accordance with the light emission timing signal supplied by the light emission timing signal generating unit 9. Thus, the light emitting element 11 outputs pulse-like laser light.

The light emitting element 11 includes a vertical cavity surface emitting laser (VCSEL) or the like as a light source.

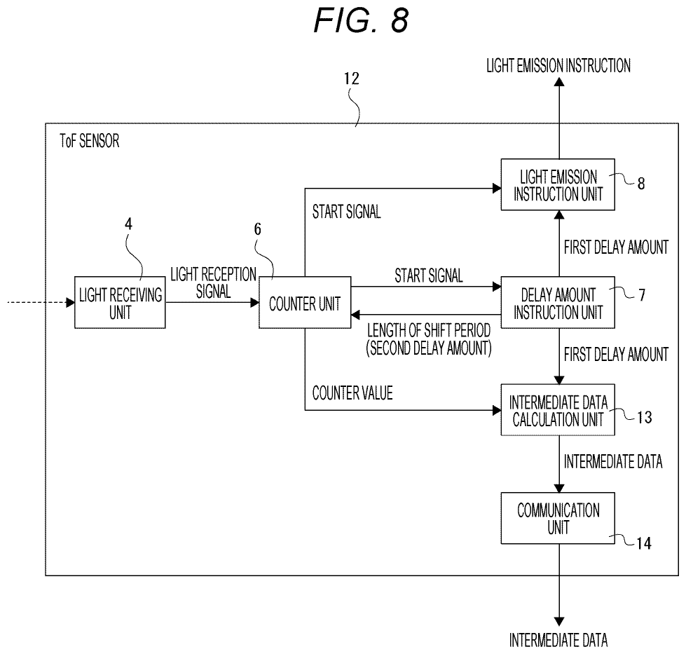

A configuration example related to the light receiving unit 4 is illustrated in FIG. 8. The light receiving unit 4 is provided as a part of a time of flight (ToF) sensor 12 including each unit of the time management unit 2.

The ToF sensor 12 includes the light receiving unit 4, the counter unit 6, the delay amount instruction unit 7, the light emission instruction unit 8, an intermediate data calculation unit 13, and a communication unit 14.

The light receiving unit 4 supports distance measurement by the ToF method, and includes a single photon avalanche diode (SPAD) element as a light receiving element of each pixel.

The counter unit 6, the delay amount instruction unit 7, and the light emission instruction unit 8 will not be described again.

The intermediate data calculation unit 13 supplies one unit distance data obtained as a result of the unit distance measurement to the communication unit 14 as intermediate data. Specifically, the intermediate data calculation unit 13 calculates a difference time between the light emission timing and the light reception timing by using the counter value supplied from the counter unit 6 and the first delay amount supplied from the delay amount instruction unit 7, and calculates a distance to the subject OB by multiplying the difference time by the light speed.

Note that the intermediate data calculation unit 13 may output the difference between the counter values as intermediate data, and the distance calculation unit 5 at a subsequent stage may be configured to calculate the distance using the light speed.

The communication unit 14 transmits the intermediate data to the distance calculation unit 5. Note that, in a case where the intermediate data transmitted by the communication unit 14 is received by another device, the transmission data may be protected using a protection function of the communication unit 14. Specifically, data for protecting the integrity of the transmission data may be transmitted together.

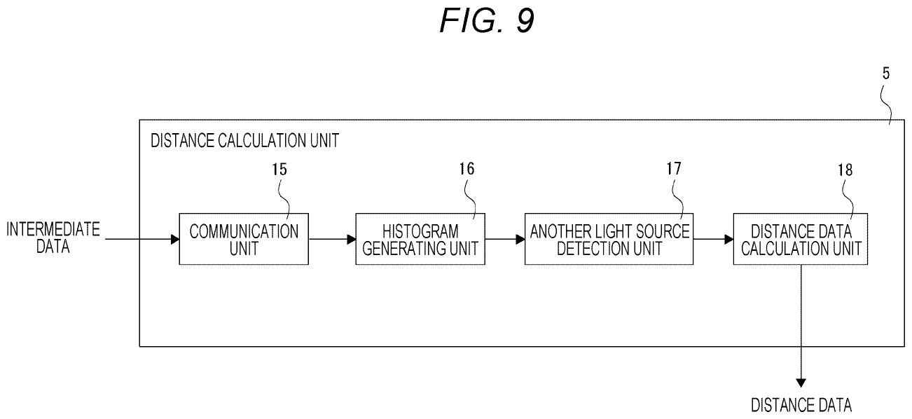

A configuration example of the distance calculation unit 5 is illustrated in FIG. 9. The distance calculation unit 5 includes a communication unit 15, a histogram generating unit 16, another light source detection unit 17, and a distance data calculation unit 18.

The communication unit 15 receives the intermediate data calculated by the intermediate data calculation unit 13 via the communication unit 14.

The histogram generating unit 16 creates a histogram by using results of a plurality of unit distance measurements received over a predetermined period (for example, a period of one frame). The histogram is generated as frequency information for each predetermined distance such as 10 cm. However, the histogram may be generated as frequency information for each difference time.

The histogram generated by the histogram generating unit 16 is supplied to the another light source detection unit 17.

The another light source detection unit 17 detects a noise component based on light emission of another light source on the basis of the histogram supplied by the histogram generating unit 16.

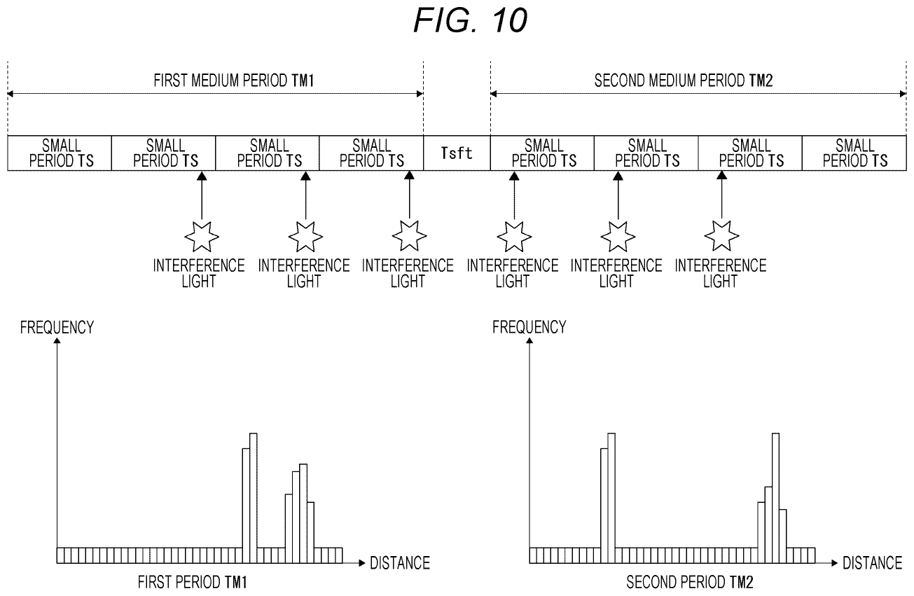

This will be specifically described with reference to FIGS. 10, 11, and 12.

A medium period TM including four small periods TS is defined as a first medium period TM1, and a medium period TM including four small periods TS following the first medium period TM1 with a shift period Tsft interposed therebetween is defined as a second medium period TM2.

In a case where interference light emitted at the same cycle as the small period TS is assumed, two peaks are detected in the first medium period TM1. One of the two peaks is obtained by detecting reflected light from the subject OB, and the other peak is obtained by detecting interference light.

Similarly, two peaks are detected also in the second medium period TM2. However, a position of the peak detected by the reflected light from the subject OB is the same as (that is, the same distance as) a peak position detected in the first medium period TM1, whereas a position of the peak detected by the interference light is different from the position of the peak detected in the first medium period TM1.

This is because the interference light repeats light emission at regular intervals without considering the shift period Tsft.

Note that, in order to make the peak position of the interference light detected in the first medium period TM1 different from the peak position of the interference light detected in the second medium period TM2, a length of the shift period Tsft needs to be different from an integral multiple of a length of the small period TS.

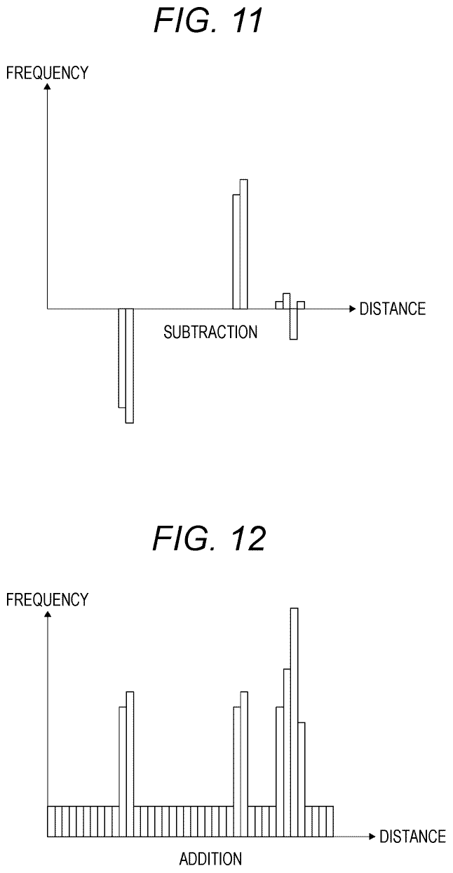

When the shift period Tsft satisfies this condition, a difference between the histogram for the first medium period TM1 (the histogram on the left side in FIG. 10) and the histogram for the second medium period TM2 (the histogram on the right side in FIG. 10) is calculated, only the peak detected by the interference light remains as illustrated in FIG. 11. As a result, it is possible to specify false distance information about the subject OB detected by the interference light.

The another light source detection unit 17 supplies, for example, false distance information as information of the another light source to the distance data calculation unit 18 in the subsequent stage together with histogram data.

The distance data calculation unit 18 calculates correct distance data for the subject OB by using only appropriate data on the basis of the false distance information supplied by the another light source detection unit 17.

Specifically, when the histogram for the first medium period TM1 and the histogram for the second medium period TM2 are added, as illustrated in FIG. 12, three pieces of distance information are obtained by appearance of both the detection result of the interference light and the detection result of the reflected light as peaks.

Among the three pieces of distance information, the distance data calculation unit 18 specifies and outputs distance information that does not correspond to false distance information as normal distance data.

### <1-2. Data Transmission>

The intermediate data and the distance data described above may be transmitted between different devices, and in the data transmission, for example, a predetermined standard such as a mobile industry processor interface (MIPI) is used.

For example, in a case where the ToF sensor 12 illustrated in FIG. 8 and the distance calculation unit 5 illustrated in FIG. 9 are different devices, intermediate data processed in accordance with a predetermined standard is transmitted from the ToF sensor 12 to the distance calculation unit 5. Furthermore, distance data processed in accordance with a predetermined standard is transmitted from the distance calculation unit 5 to another device.

Here, communication conforming to MIPI will be described as an example.

The transmission of the intermediate data and the distance data is performed every large period TL including a plurality of the medium periods TM.

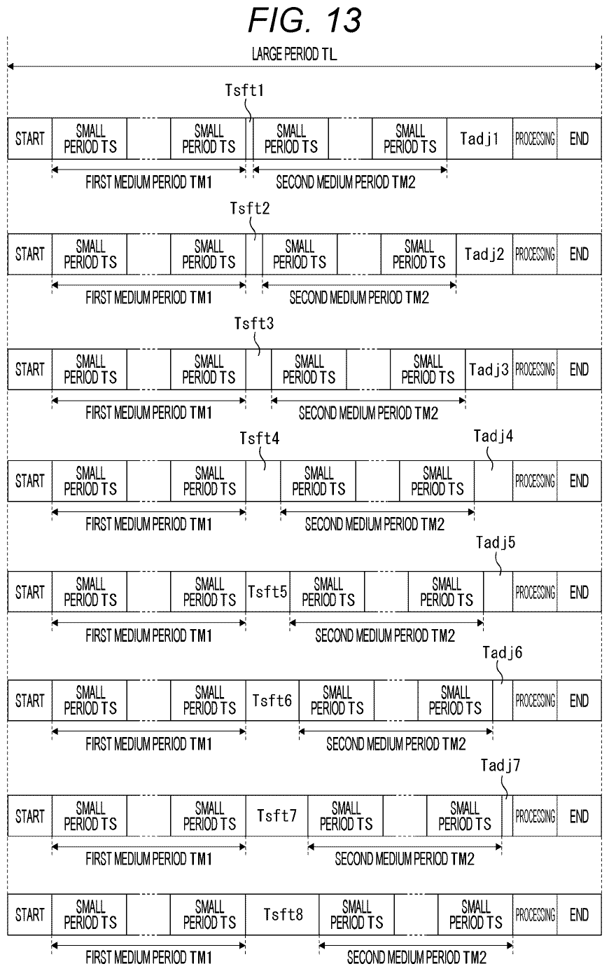

Here, the large period TL will be described with reference to FIG. 13.

First, the small period TS is unit distance measurement in which light emission and light reception are performed once as described above. Furthermore, the medium period TM is a period in which the small periods TS continue.

The large period TL corresponds to one frame period for generating a distance image, and includes the plurality of medium periods TM. The large period TL illustrated in FIG. 13 includes a first medium period TM1 and a second medium period TM2.

The large period TL includes a start period (“start” in the drawing) in which frame start processing is performed, a first medium period TM1 and a second medium period TM2, a shift period Tsft provided between the medium periods TM, an adjustment period Tadj, a processing period (“processing” in the drawing) in which storage processing in a memory or the like is performed, and an end period (“end” in the drawing) in which frame end processing is performed.

Time lengths of the large periods TL are unified, and the total time of the shift period Tsft and the adjustment period Tadj is the same in any large period TL. That is, the total time of the shift period Tsft1 and the adjustment period Tadj1 and the total time of the shift period Tsft2 and the adjustment period Tadj2 are the same.

Note that the adjustment period Tadj8 corresponding to the shift period Tsft8 has a time length of “0”. That is, a time length of the shift period Tsft8 is the same as the total time of the shift period Tsft1 and the adjustment period Tadj1.

In other words, the adjustment period Tadj is a period provided according to the length of the shift period Tsft so that the large periods TL have the same time length. The, the adjustment period Tadj may not be provided depending on the length of the shift period Tsft.

Note that a length of each of the shift periods Tsft1 to Tsft8 is different from an integral multiple of the length of the small period TS.

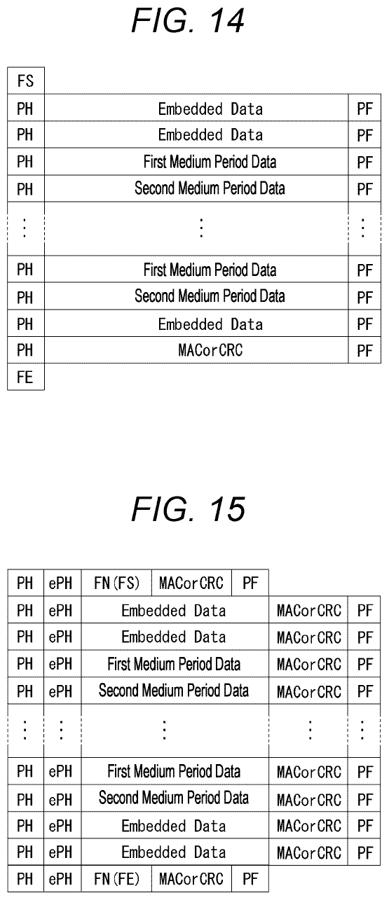

FIG. 14 illustrates an example of a packet structure in which the intermediate data output for each large period TL is stored.

The intermediate data of one frame period is stored and transmitted at a predetermined position in the data format of a series of MIPIs starting with a frame start (“FS” in the drawing) and ending with a frame end (“FE” in the drawing).

Here, the packet data conforming to MIPI (hereinafter referred to as “MIPI data”) may be transmitted in a processing period (“processing” in the drawing) illustrated in FIG. 13, or may be transmitted while distance measurement of the next one frame is performed. Furthermore, the transmission may be performed over a plurality of frames.

In the MIPI data, a plurality of packets is continuously transmitted between a frame start and a frame end. Each packet includes a packet header (“PH” in the drawing), a payload area, and a packet footer (“PF” in the drawing), and various types of transmission data are stored in the payload area.

FIG. 14 illustrates an example in which embedded data (“Embedded Data” in the figure), first medium period data, second medium period data, a message authentication code (MAC) value or a cyclic redundancy code (CRC) value as additional data for protecting transmission data by securing confidentiality or integrity of the transmission data are stored in a payload area.

Here, the first medium period data is one or a plurality of unit distance data measured in the first medium period TM1 in FIG. 13, and is intermediate data for calculating the distance data.

Furthermore, the second medium period data is one or a plurality of unit distance data measured in the second medium period TM2 in FIG. 13, and is intermediate data for calculating the distance data.

As the first medium period data and the second medium period data, a plurality of pieces of unit distance data measured in the same pixel may be continuously stored, or unit distance data for a plurality of pixels measured in one small period TS may be continuously stored.

Another example of the MIPI data is illustrated in FIG. 15.

The example illustrated in FIG. 15 may use the packet structure of the extension packet.

For example, an extension packet header (“ePH” in the drawing), transmission data (intermediate data), a MAC value, and a CRC value are stored in a payload area of packet data. The similarity applies to the following examples, but the transmission data may include either one or both of the MAC value and the CRC value.

Note that the extension packet footer may be stored in the payload area of the packet data.

Here, some examples will be given of modifications of a mode in which the intermediate data is stored in the payload area.

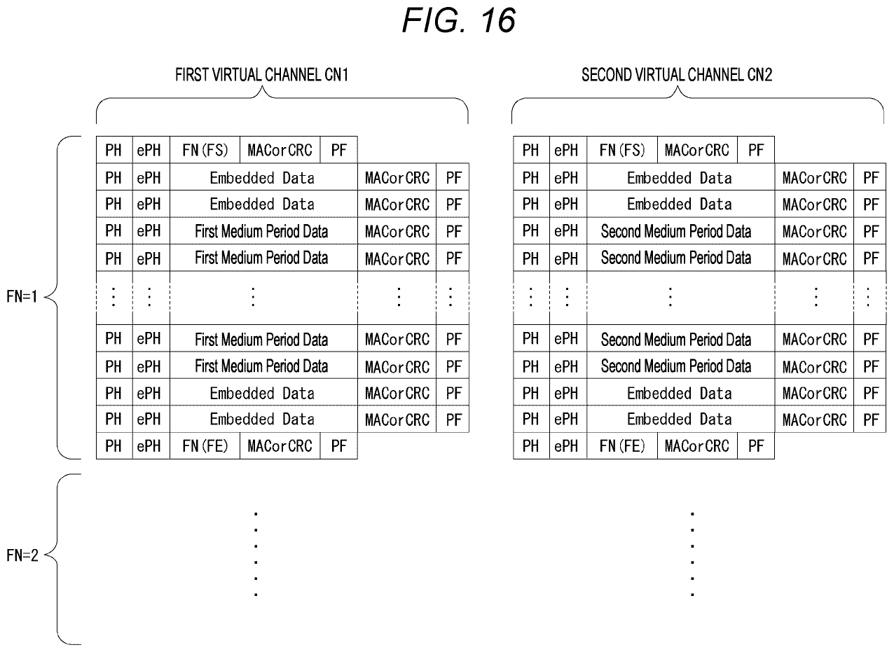

FIG. 16 illustrates a first modification. In the first modification, a first virtual channel CN1 and a second virtual channel CN2 in the MIPI are used, the first virtual channel CN1 transmits a packet in which the first medium period data is stored in the payload area, and the second virtual channel CN2 transmits a packet in which the second medium period data is stored in the payload area. Note that “EN” in the drawing indicates a frame number.

That is, the first medium period data and the second medium period data are separately transmitted.

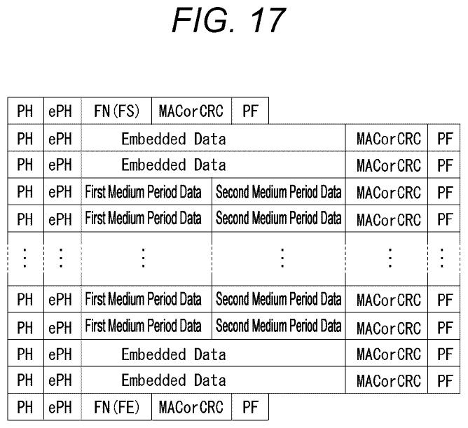

FIG. 17 illustrates a second modification.

In the second modification, the first medium period data and the second medium period data are mixed and transmitted in the payload area of one packet.

Here, in a mode of the mixture of the first medium period data and the second medium period data, the first medium period data along the arrangement of pixels may be continuously stored, and then the second medium period data corresponding to the first medium period data may be stored (FIG. 17), or the first medium period data and the second medium period data in the pixels may be set, and the set of data may be continuously stored, that is, the first medium period data and the second medium period data may be alternately stored in one payload area.

Note that, in a case where the large period TL includes three or more n medium periods TM, n pieces of medium period data may be included in the payload area of one packet.

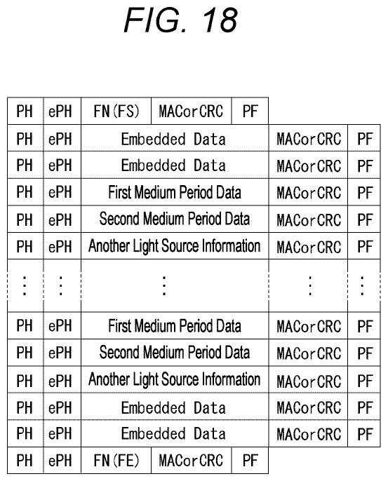

FIG. 18 illustrates a third modification.

In the third modification, packet data in which another light source information is stored in the payload area is transmitted. Any storage mode of the another light source information may be used. For example, as illustrated in FIG. 18, a packet in which the another light source information is stored in the payload area may be transmitted after a packet in which the first medium period data is stored in the payload area and a packet in which the second medium period data is stored in the payload area.

Furthermore, the first medium period data, the second medium period data, and the another light source information may be transmitted using a plurality of virtual channels CN as illustrated in FIG. 16, or the first medium period data, the second medium period data, and the another light source information may be stored in a set in a payload area of one packet as illustrated in FIG. 17.

Note that the another light source information may be stored in another area other than the payload area, such as a packet header, an extension packet header, or embedded data.

The first medium period data and the second medium period data illustrated in each drawing may be unit distance data calculated as intermediate data in each medium period TM, or may be frequency data of a histogram as intermediate data generated on the basis of the unit distance data calculated in the medium period TM.

The embedded data illustrated in each drawing may include setting information of each device, a register value according to a standard, a vendor-specific register value, description of a frame format, a statistical value, and the like.

Furthermore, the embedded data may include distance data, image data, information regarding user defined data, or the like.

### <1-3. Processing Flow>

An example of processing executed by the ToF sensor 12 and the distance calculation unit 5 will be described.

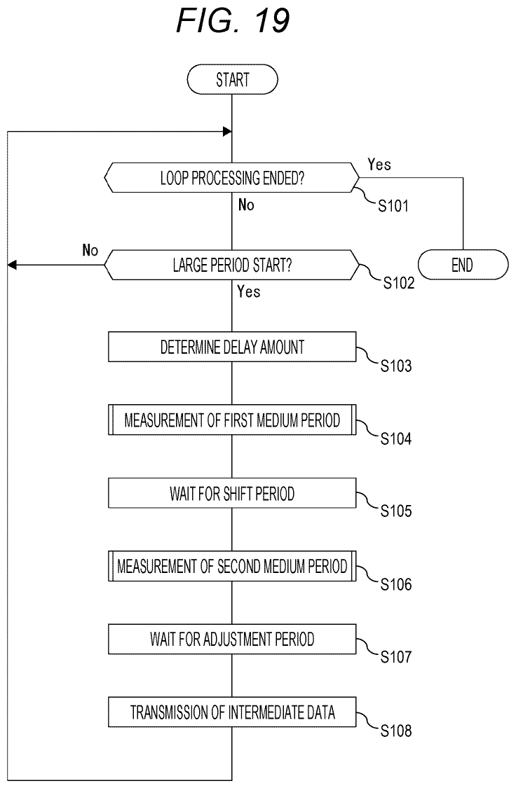

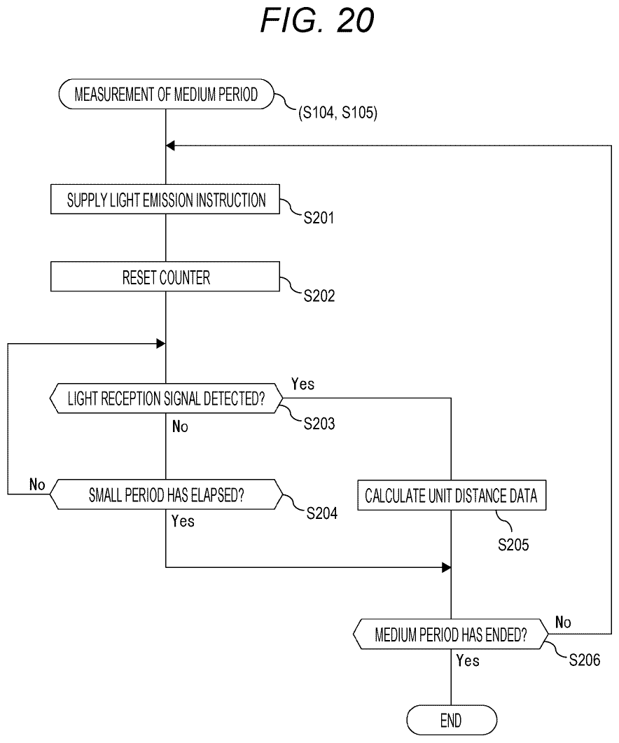

FIGS. 19 and 20 are examples of processing executed by the ToF sensor 12.

In step S101, a processing unit (hereinafter simply referred to as a “processing unit”) such as a central processing unit (CPU) in the ToF sensor 12 determines whether or not to end the loop processing. This determination processing is processing of determining whether to end a series of loop processing related to distance measurement.

In a case where it is determined that the loop processing is ended, the processing unit of the ToF sensor 12 ends a series of processing illustrated in FIG. 19.

On the other hand, in a case where it is determined that the loop processing is continued, the processing unit of the ToF sensor 12 determines whether or not the large period TL is started in step S102. In a case where it is determined that the start timing of the large period TL has not yet come, the processing unit of the ToF sensor 12 returns to the processing of step S101.

On the other hand, in a case where it is determined that the start timing of the large period TL has arrived, the delay amount instruction unit 7 of the ToF sensor 12 determines the first delay amount and the second delay amount in step S103. The processing of step S103 may be processing of selecting one of the first delay amount and the second delay amount for each predetermined large period TL using a random number (including a pseudo random number) or the like, or may be processing of determining each delay amount using a random number or the like at an execution timing of step S103.

Alternatively, as the processing of step S103, each delay amount may be determined for each large period TL along a pattern table prepared in any device such as the light emitting unit 3, the TOF sensor 12, or the distance calculation unit 5.

Only one such pattern table may be prepared, or a plurality of such pattern tables may be prepared. In a case where a plurality of the pattern tables is prepared, a processing of selecting one pattern table may be performed at the start of distance measurement.

After determining each delay amount, the processing unit of the ToF sensor 12 starts measurement of the first medium period TM1 in step S104.

Here, an example of processing executed by the processing unit of the ToF sensor 12 in the measurement in the medium period TM is illustrated in FIG. 20. Note that the processing illustrated in FIG. 20 is processing executed also in the subsequent measurement in the second medium period TM2, and is a generalization of the processing executed in each medium period TM.

In the first medium period TM1, the light emission instruction unit 8 of the ToF sensor 12 supplies a light emission instruction in step S201. As described above, this light emission instruction is supplied to the light emitting unit 3 on the basis of the start signal supplied by the counter unit 6 and the first delay amount supplied by the delay amount instruction unit 7.

Subsequently, the processing unit of the ToF sensor 12 resets the counter managed by the counter unit 6 in step S202. Note that, in a case where the light emission instruction is issued after a lapse of a predetermined time after the start of the small period TS, the counter reset in step S202 is performed, and the light emission instruction in step S201 is supplied to standby for a predetermined time.

The processing unit of the ToF sensor 12 determines whether or not a light reception signal by the light receiving unit 4 has been detected in step S203. In a case where it is determined that the light reception signal is not detected, the processing unit of the ToF sensor 12 further determines whether or not the small period TS has elapsed in step S204. In a case where it is determined that the small period TS has not elapsed, the processing unit of the ToF sensor 12 returns to the processing of step S203 again.

That is, the processing unit of the ToF sensor 12 repeats the determination processing of steps S203 and S204 until the light reception signal is detected or the small period TS elapses.

Note that, in a case where the small period TS includes the light receiving period Ta and the non-light receiving period Tb, and at least a part of the non-light receiving period Tb is provided after the light receiving period Ta, it is determined in step S204 whether the light receiving period Ta has elapsed.

In a case where it is determined in step S203 that the light reception signal is detected, on the basis of the first delay amount determined in step S103, the intermediate data calculation unit 13 of the ToF sensor 12 calculates the unit distance data as the intermediate data in step S205.

In step S206, the processing unit of the ToF sensor 12 determines whether or not the medium period TM has ended. In a case where it is determined that the medium period TM has ended, the processing unit of the ToF sensor 12 ends the series of processing illustrated in FIG. 20.

Note that, in a case where it is determined in step S204 that the small period TS has elapsed, that is, in a case where the reception of the reflected light cannot be confirmed in the period in which the reflected light should be received in the small period TS, the processing proceeds to the determination processing in step S206 without calculating the unit distance data in step S205.

The description returns to FIG. 19.

After finishing the measurement in the first medium period TM1, in step S105, the processing unit of the ToF sensor 12 waits for the shift period based on the second delay amount determined in step S103.

After waiting for the shift period, the processing unit of the ToF sensor 12 starts measurement in the second medium period TM2 in step S106 to execute the series of processing illustrated in FIG. 20.

Then, after completing the measurement in the second medium period TM2, the processing unit of the ToF sensor 12 waits for the adjustment period Tadj in step S107.

In step S108, the processing unit of the ToF sensor 12 causes the communication unit 14 to execute processing for outputting the first medium period data and the second medium period data to the distance calculation unit 5.

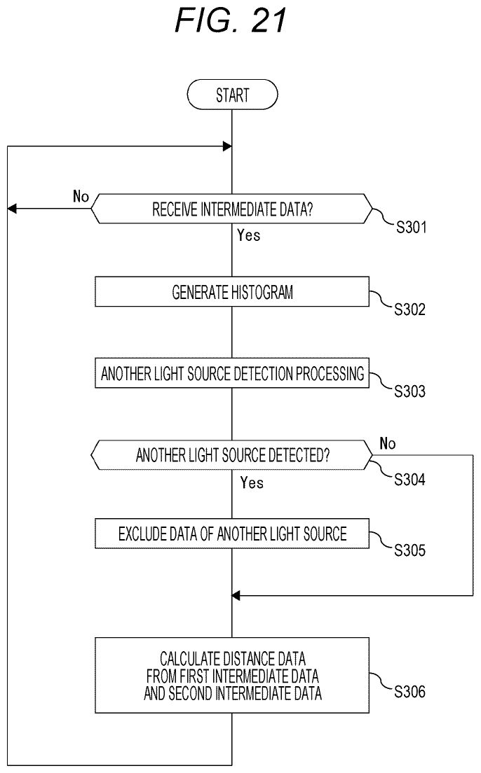

Next, an example of processing executed by a processing unit (Hereinafter, simply referred to as a “processing unit”) such as a CPU in the distance calculation unit 5 is illustrated in FIG. 21.

In step S301, the processing unit of the distance calculation unit 5 determines whether or not the communication unit 15 has received the first medium period data and the second medium period data from the ToF sensor 12.

In a case where it is determined that the medium period data has not been received, the processing of step S301 is repeatedly executed.

In a case where it is determined that the medium period data has been received, the histogram generating unit 16 of the distance calculation unit 5 generates a histogram in step S302.

Subsequently, the another light source detection unit 17 of the distance calculation unit 5 performs another light source detection processing in step S303.

The processing unit of the distance calculation unit 5 determines whether or not the another light source has been detected in step S304. In a case where it is determined that the another light source has been detected, the processing unit of the distance calculation unit 5 excludes data of the another light source in step S305.

In step S306, the distance data calculation unit 18 of the distance calculation unit 5 calculates distance data from the first medium period data and the second medium period data.

Note that, in a case where it is determined in step S304 that no another light source is detected, the processing unit of the distance calculation unit 5 causes the distance data calculation unit 18 to calculate the distance data in step S306 without executing the processing in step S305.

### 2. Second Embodiment

In a second embodiment, the ToF sensor 12 in the first embodiment is a ToF sensor 12A having the function of the distance calculation unit 5.

A distance measuring system 1A according to the present embodiment includes a light emitting unit 3A and the ToF sensor 12A.

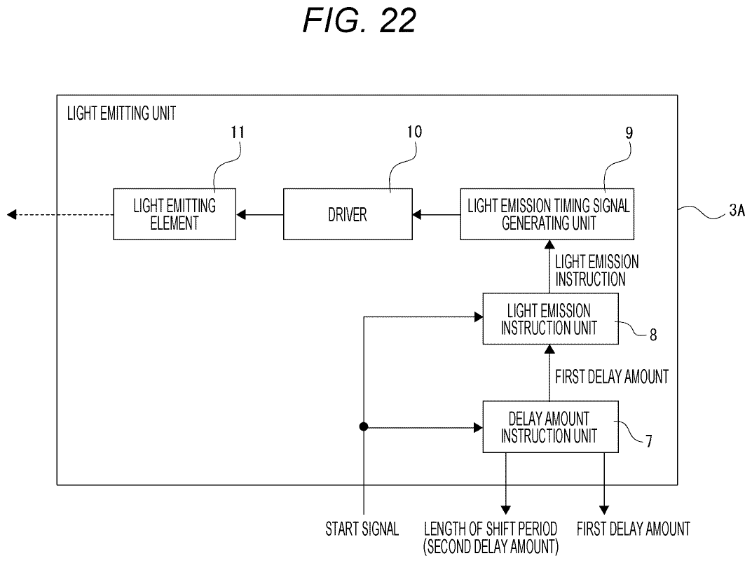

The light emitting unit 3A includes a part of the time management unit 2 illustrated in FIG. 2. Specifically, as illustrated in FIG. 22, the light emitting unit 3A includes a delay amount instruction unit 7, a light emission instruction unit 8, a light emission timing signal generating unit 9, a driver 10, and a light emitting element 11.

The light emitting unit 3A receives a start signal indicating a start timing of the small period TS from the ToF sensor 12, and the delay amount instruction unit 7 determines a first delay amount on the basis of the start signal.

The light emission instruction unit 8 supplies a light emission instruction to the light emission timing signal generating unit 9 on the basis of the start signal and the first delay amount determined by the delay amount instruction unit 7.

When the light emission timing signal generating unit 9, the driver 10, and the light emitting element 11 perform predetermined operations in response to the light emission instruction, pulse-like laser light is output at a timing delayed by the predetermined first delay amount from the start timing of the small period TS.

Note that the delay amount instruction unit 7 determines a length of the shift period as a second delay amount, and supplies the second delay amount to the ToF sensor 12A together with the first delay amount.

The ToF sensor 12A includes a counter unit 6 as a part of the function of the time management unit 2.

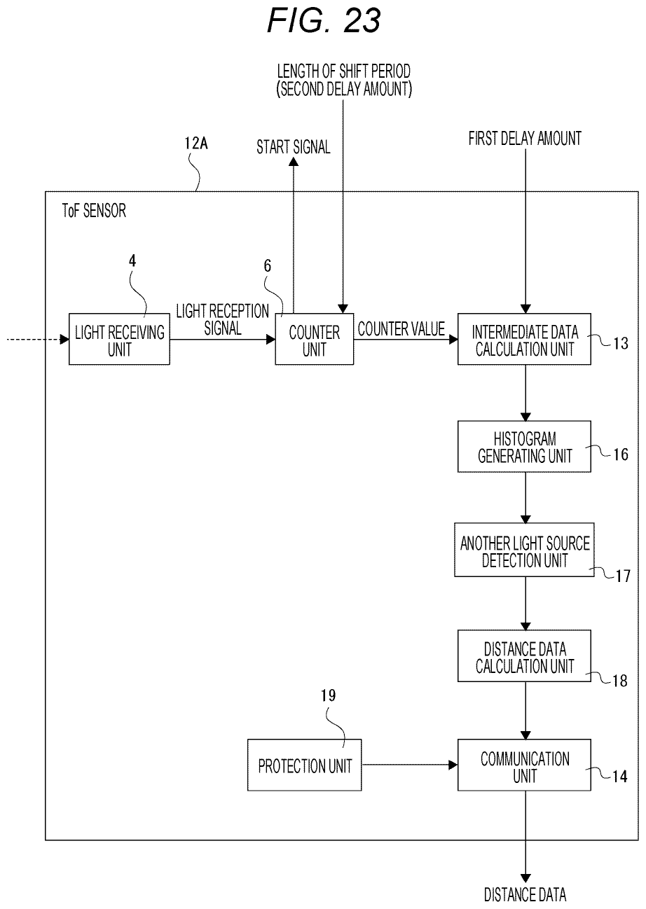

Specifically, as illustrated in FIG. 23, the ToF sensor 12A includes a light receiving unit 4, the counter unit 6, an intermediate data calculation unit 13, a histogram generating unit 16, another light source detection unit 17, a distance data calculation unit 18, a communication unit 14, and a protection unit 19.

The counter unit 6 includes a counter reset at the start timing of the small period TS, and supplies a start signal for indicating the start timing of the small period TS to the light emitting unit 3A. Furthermore, the counter unit 6 resets the counter on the basis of a second delay amount as a length of the shift period.

The light receiving unit 4 outputs a light reception signal to the counter unit 6 in a case where light reception is detected by a SPAD element.

The counter unit 6 outputs a counter value according to the timing at which the light reception signal is received to the intermediate data calculation unit 13.

The intermediate data calculation unit 13 calculates unit distance data as intermediate data on the basis of the counter value supplied from the counter unit 6 and the first delay amount supplied from the light emitting unit 3A, and outputs the unit distance data to the histogram generating unit 16.

The histogram generating unit 16 creates a histogram by using the unit distance data received over one frame period.

The another light source detection unit 17 detects the presence of another light source on the basis of the histogram generated by the histogram generating unit 16.

The distance data calculation unit 18 calculates correct distance data for the subject OB using the false distance information supplied by the another light source detection unit 17.

The protection unit 19 performs processing for protecting the calculated distance data. For example, the protection unit 19 may perform various types of processing using a CRC value, a MAC value, or the like as processing for securing integrity, or may perform processing of encrypting distance data as transmission data using some encryption technology as processing for securing confidentiality.

The communication unit 14 transmits the distance data protected by the protection unit 19 to another device.

By performing each processing until the distance data is calculated in the ToF sensor 12A, it is possible to strongly protect privacy of the measurement data.

Note that the distance calculation unit 5 in the first embodiment illustrated in FIG. 9 may be provided with a protection unit 19 that applies the above-described protection function when transmitting the distance data calculated by the distance data calculation unit 18 to an external device.

### 3. Third Embodiment

A distance measuring system 1B according to a third embodiment includes a light emitting unit 3B, a ToF sensor 12B, and a distance calculation unit 5, and the ToF sensor 12B grasps light emission timing by receiving reflected light in which light emitted from the light emitting unit 3B is reflected inside the distance measuring system 1B. For this purpose, the distance measuring system 1B further includes a reflection unit 20.

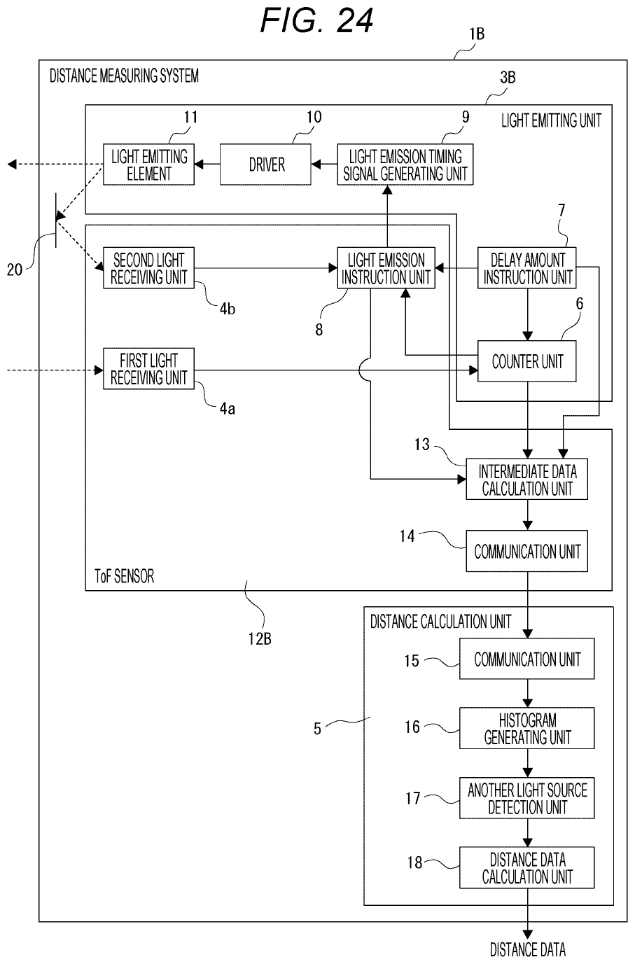

Specifically, as illustrated in FIG. 24, the light emitting unit 3B includes a counter unit 6, a delay amount instruction unit 7, a light emission timing signal generating unit 9, a driver 10, and a light emitting element 11.

The configuration of each unit will not be described again. Note that, unlike the second embodiment, the light emitting unit 3B does not include a light emission instruction unit 8, and instead, the ToF sensor 12B includes the light emission instruction unit 8.

Specifically, the ToF sensor 12B includes a first light receiving unit 4a, a second light receiving unit 4b, the light emission instruction unit 8, an intermediate data calculation unit 13, and a communication unit 14.

In the ToF sensor 12B, the similar configuration to that of the other embodiments will not be described again.

The first light receiving unit 4a performs a function equivalent to that of the light receiving units 4 and 4A in the first and second embodiments, and receives first reflected light in which light emitted from the light emitting unit 3B is reflected by a subject OB.

The second light receiving unit 4b has a configuration unique to the third embodiment, and grasps the light emission timing of the light emitting unit 3B by receiving second reflected light in which the light emitted from the light emitting unit 3B is reflected by the reflection unit 20 provided inside the distance measuring system 1B.

The light reception signal in the second light receiving unit 4b is supplied to the light emission instruction unit 8. The light reception signal corresponds to a start signal in the other embodiments described above. That is, the light emission instruction unit 8 generates a light emission instruction for the next light emission on the basis of the reception signal supplied from the second light receiving unit 4b and the first delay amount determined by the delay amount instruction unit 7, and supplies the light emission instruction to the light emission timing signal generating unit 9.

Since the configuration of the distance calculation unit 5 is similar to that of the other embodiments described above, redundant description is avoided.

Note that the first light receiving unit 4a and the second light receiving unit 4b may be provided as a light receiving unit having one pixel array unit. For example, the first reflected light may be received in an effective pixel region in the pixel array unit, and the second reflected light may be received in a peripheral region of the effective pixel region in the pixel array unit. As a result, the number of components is reduced, which contributes to cost reduction.

The reflection unit 20 may be provided in the light emitting unit 3B, may be provided in the ToF sensor 12B, or may be provided in a portion other than the light emitting unit 3B and the ToF sensor 12B in the distance measuring system 1B.

### 4. Modification of Shift Period

The shift periods Tsft1 to Tsft8 for each large period TL illustrated in FIG. 13 are illustrated as a mode in which the shift period Tsft becomes longer for each large period TL. Some modifications will be described for other modes. Note that, in the following modifications, an example in which eight types of shift periods Tsft1 to Tsft8 are prepared similarly to FIG. 13 will be described, but any shift period may be prepared as long as there is a plurality of types.

### 4-1. Modification 1

The shift periods Tsft1 to Tsft8 randomly rearranged may be applied in order from the first large period TL to the eighth large period TL.

Furthermore, one of the eight shift periods Tsft1 to Tsft8 may be randomly selected for each large period TL. That is, the shift period Tsft1 may be selected a plurality of times or may be continuously selected in the eight large periods TL.

Note that, in order to unify the lengths of the large periods TL, the adjustment period Tadj in the large period TL in which the shift period Tsft1 is selected is set as the adjustment period Tadj1, and the adjustment period Tadj in the large period TL in which the shift period Tsft2 is selected is set as the adjustment period Tadj2.

### 4-2. Modification 2

A plurality of shift periods Tsft may be provided in one large period TL.

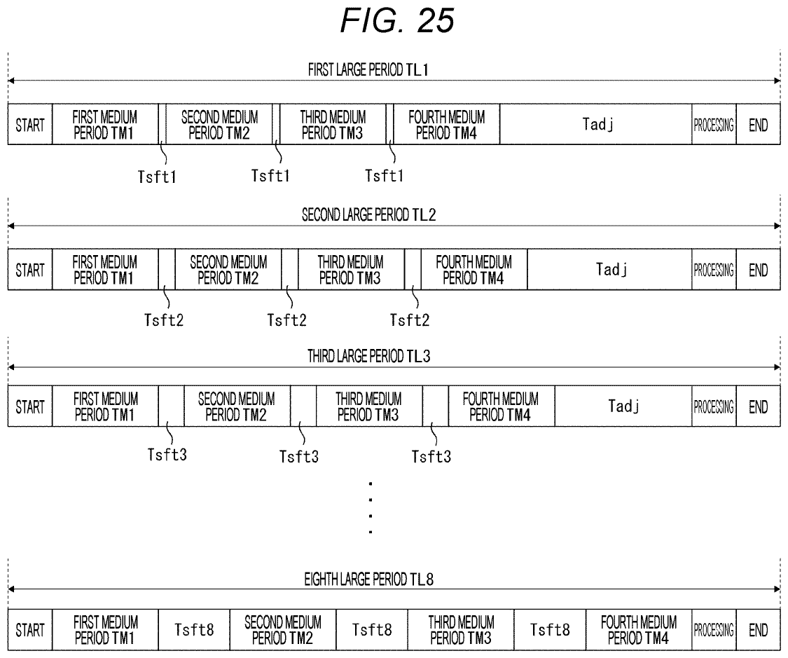

For example, in the example of FIG. 25, four medium periods TM are included in the large period TL, and three shift periods Tsft are provided between the medium periods TM.

The lengths of the plurality of shift periods Tsft included in one large period TL are unified.

Specifically, first, shift periods Tsft1 to Tsft8 are prepared. The shift period Tsft1 has the shortest period length, and the shift period Tsft8 has the longest period length.

The shift period Tsft1 is provided between each of the first medium period TM1, the second medium period TM2, the third medium period TM3, and the fourth medium period TM4 in the first large period TL1.

The shift period Tsft2 is provided between the respective medium periods TM in the second large period TL2.

The shift period Tsft3 is provided between the respective medium periods TM in the third large period TL3.

The shift period Tsft8 is provided between the respective medium periods TM in the eighth large period TL8.

After the fourth medium period TM4 of each of the first large period TL1, the second large period TL2, and the third large period TL3, adjustment periods Tadj having different lengths are provided to unify the time length of the large period TL.

Note that the plurality of shift periods Tsft included in the large period TL may be combined so that the length of the large period TL becomes short.

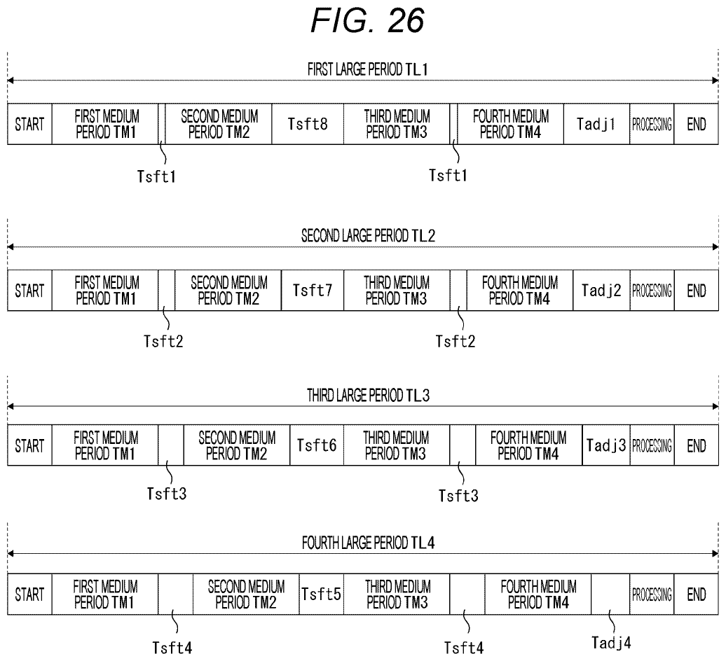

For example, as illustrated in FIG. 26, the shortest shift period Tsft1 and the longest shift period Tsft8 may be combined and included in the first large period TL1, and the second shortest shift period Tsft2 and the second longest shift period Tsft7 may be combined and included in the second large period TL2.

In this manner, by successfully combining the long shift period Tsft and the short shift period Tsft, the length of the large period TL can be shortened. Furthermore, the processing period (“processing” in the drawing) can be lengthened instead of shortening the length of the large period TL, and it is possible to increase the amount of calculation that can be executed and use a calculation unit having low processing capability.

Furthermore, four shift periods Tsft may be prepared to be included in each of the large periods TL, three shift periods Tsft selected from the four shift periods Tsft may be disposed between the respective medium periods TM, and an adjustment period Tadj having the same length as the shift period Tsft that has not been selected may be disposed after the fourth medium period TM4.

As a result, the length of the large period TL can be unified.

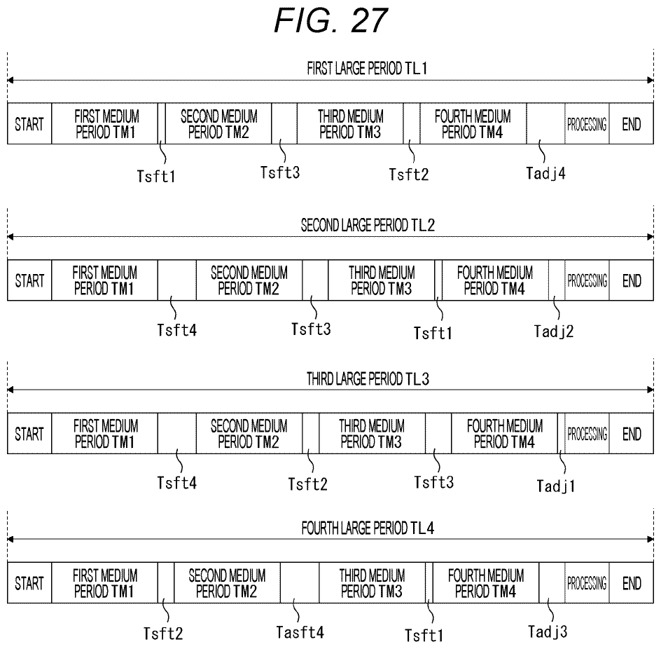

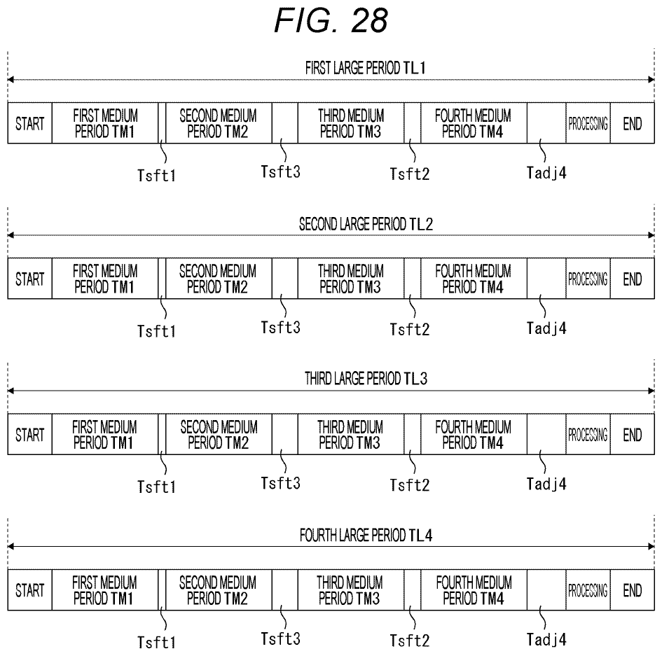

Note that the selection of the three shift periods Tsft may be different for each large period TL (see FIG. 27), or may be unified for each large period TL (see FIG. 28).

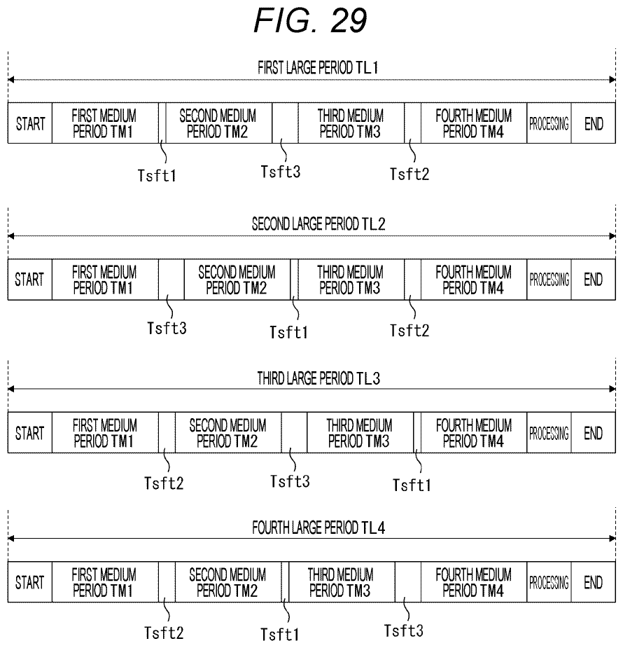

Note that, as illustrated in FIG. 29, three types (shift periods Tsft1, Tsft2, and Tsft3) of shift periods Tsft may be prepared and disposed so as not to overlap during the medium period TM. As a result, it is not necessary to provide the adjustment period Tadj, and the length of the large period TL can be shortened.

### 4-3. Modification 3

The small period TS may include a light receiving period Ta and a non-light receiving period Tb, and the non-light receiving period Tb may further include a pre-delay period TwA provided before the light receiving period Ta and a post-delay period TwB provided after the light receiving period Ta.

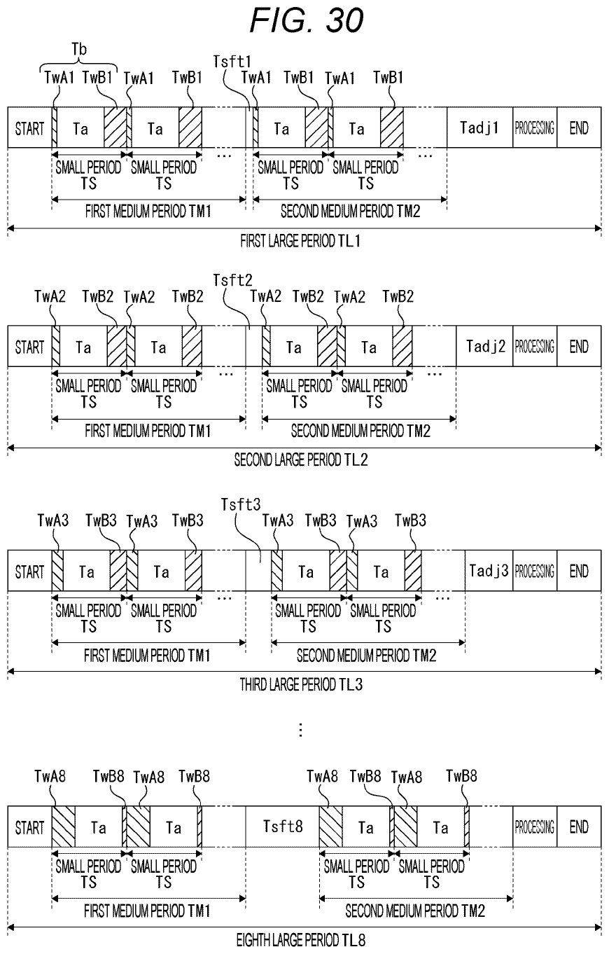

This will be specifically described with reference to FIG. 30. Note that, in FIG. 30 and the subsequent drawings, the pre-delay period TwA and the post-delay period TwB are indicated as shaded regions having different orientations.

As illustrated, the first large period TL1 includes a plurality of small periods TS, and each small period TS includes a light receiving period Ta, a pre-delay period TwA1 provided before the light receiving period Ta, and a post-delay period TwB1 provided after the light receiving period Ta.

In the first large period TL1, a shift period Tsft1 is provided between the first medium period TM1 and the second medium period TM2, and an adjustment period Tadj1 corresponding to the period length of the shift period Tsft1 is provided after the second medium period TM2.

Furthermore, the small period TS of the second large period TL2 includes a pre-delay period TwA2, a light receiving period Ta, and a post-delay period TwB2. Then, the pre-delay period TwA2 is made longer than the pre-delay period TwA1, and the post-delay period TwB2 is made shorter than the post-delay period TwB1.

Then, the total length of the pre-delay period TwA2 and the post-delay period TwB2 is made equal to the total length of the pre-delay period TwA1 and the post-delay period TwB1. Therefore, the length of the small period TS is the same in the first large period TL1 and the second large period TL2.

In the second large period TL2, a shift period Tsft2 is provided between the first medium period TM1 and the second medium period TM2, and an adjustment period Tadj2 corresponding to the period length of the shift period Tsft2 is provided after the second medium period TM2.

Then, the total length of the shift period Tsft2 and the adjustment period Tadj2 is the same as the total length of the shift period Tsft1 and the adjustment period Tadj1.

Similarly, from the third large period TL3 to the eighth large period TL8, the length of the pre-delay period TwA gradually increases, the length of the post-delay period TwB gradually decreases, the length of the shift period Tsft gradually increases, and the length of the adjustment period Tadj gradually decreases.

Note that, in the eighth large period TL8, the adjustment period Tadj is not provided. In other words, the adjustment period Tadj is provided after the second medium period TM2 in the first large period TL1 to the seventh large period TL7 according to the length of the eighth large period TL8 in which the adjustment period Tadj is not provided.

Note that, in FIG. 30, the length of the pre-delay period TwA included in the large period TL is gradually increased from the first large period TL1 toward the eighth large period TL8, and the length of the post-delay period TwB is gradually decreased from the first large period TL1 toward the eighth large period TL8.

The present invention is not limited thereto, and the pre-delay period TwA and the post-delay period TwB for each large period TL may have random lengths.

### 4-4. Modification 4

The small period TS may include the light receiving period Ta and the non-light receiving period Tb, and the non-light receiving period Tb may include only the pre-delay period TwA without including the post-delay period TwB.

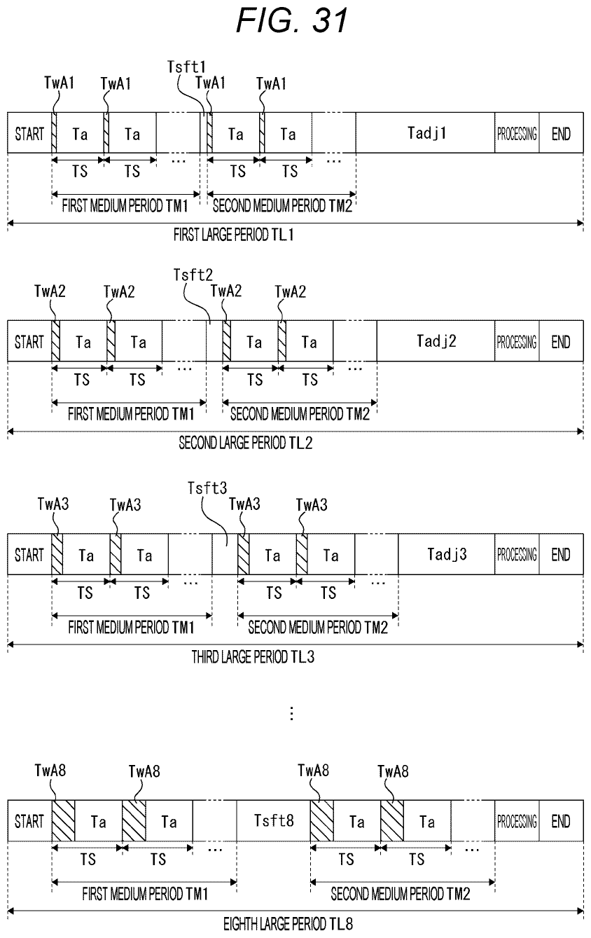

Specifically, as illustrated in FIG. 31, the small period TS includes only the pre-delay period TwA as the non-light receiving period Tb and the light receiving period Ta, and the ratio of the lengths of the pre-delay period TwA and the light receiving period Ta is unchanged within the same large period TL. Furthermore, in the comparison between the different large periods TL, the length of the pre-delay period TwA with respect to the light receiving period Ta is different.

The adjustment period Tadj following the second medium period TM2 is provided according to the lengths of the pre-delay period TwA and the shift period Tsft in order to unify the lengths of the large period TL.

Note that the length of the small period TS can be shortened by an amount in which the small period TS does not include the post-delay period TwB. Therefore, one large period TL can include many small periods TS and medium periods TM.

In the example illustrated in FIG. 31, the length of the pre-delay period TwA is gradually increased for each large period TL. However, the length of the pre-delay period TwA may be set to be gradually decreased, or may be set to a random length.

Furthermore, as a further modification in FIG. 31, the length of the pre-delay period TwA2 in the second large period TL2 may be made longer than the pre-delay period TwA1 in the first large period TL1, and the length of the shift period Tsft2 in the second large period TL2 may be made shorter than the shift period Tsft1 in the first large period TL1. That is, an increase in the length of the pre-delay period TwA2 may be absorbed by shortening the shift period Tsft2. As a result, the adjustment period Tadj can be shortened or deleted, and the length of the large period TL can be shortened and the frame period can be shortened.

### 4-5. Modification 5

The small period TS may include the light receiving period Ta and the non-light receiving period Tb, and the non-light receiving period Tb may include the post-delay period TwB and may not include the pre-delay period TwA.

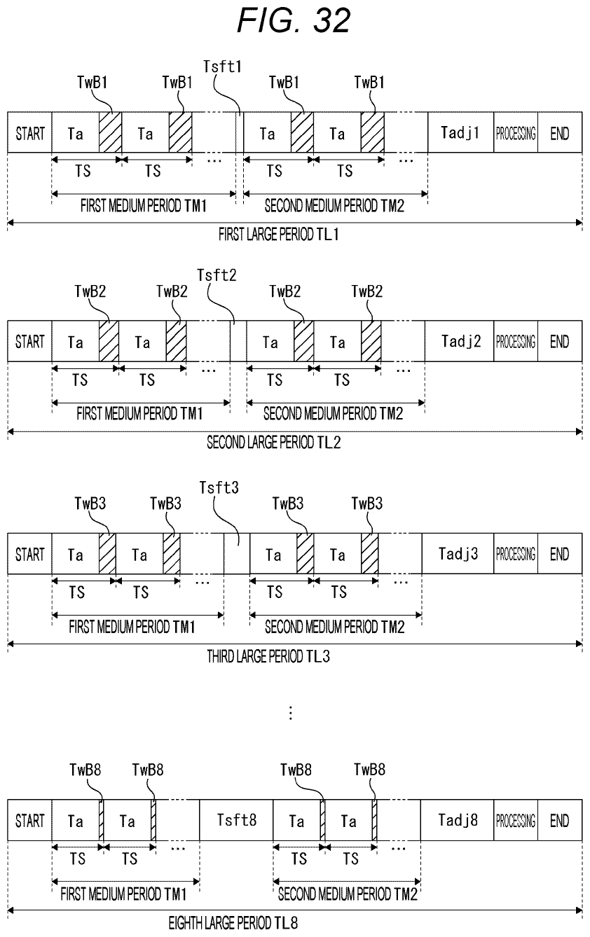

Specifically, as illustrated in FIG. 32, the small period TS includes only the light receiving period Ta and the post-delay period TwB, and the ratio of the lengths of the post-delay period TwB and the light receiving period Ta is unchanged within the same large period TL.

Furthermore, in the comparison between the different large periods TL, the length of the post-delay period TwB with respect to the light receiving period Ta is different.

The adjustment period Tadj following the second medium period TM2 is provided as necessary based on the lengths of the post-delay period TwB and the shift period Tsft in order to unify the lengths of the large period TL.

Note that the length of the small period TS can be shortened by an amount in which the small period TS does not include the pre-delay period TwA. Therefore, one large period TL can include many medium periods TM.

In the example illustrated in FIG. 32, an example in which the length of the post-delay period TwB is gradually shortened every large period TL is illustrated. However, the length of the post-delay period TwB may be set to be gradually longer, or may be set to a random length.

As illustrated in FIG. 32, the total of the lengths of the post-delay period TwB and the shift period Tsft can be unified or approximated by gradually shortening the post-delay period TwB and gradually increasing the shift period Tsft. As a result, the adjustment period Tadj can be shortened or deleted, and the length of the large period TL can be shortened and the frame period can be shortened.

### 4-6. Modification 6

In the configuration in which the small period TS includes the light receiving period Ta and the non-light receiving period Tb, and the non-light receiving period Tb does not include the post-delay period TwB but includes only the pre-delay period TwA, the length of the pre-delay period TwA may be different for each medium period TM included in the large period TL. That is, the length of the pre-delay period TwA may be different in the same large period TL.

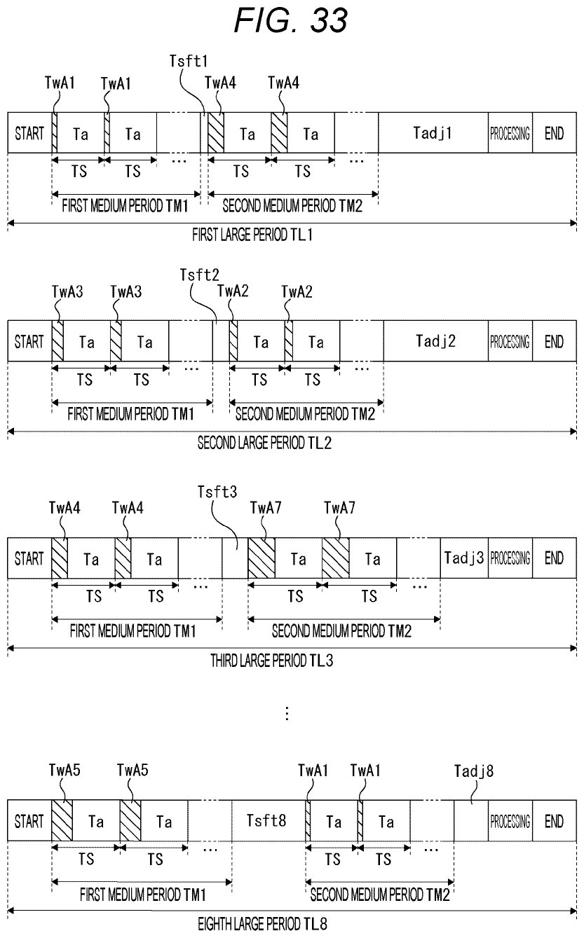

Specifically, as illustrated in FIG. 33, in the first medium period TM1 in the first large period TL1, the small period TS includes the pre-delay period TwA1, and in the second medium period TM2, the small period TS includes the pre-delay period TwA4.

Similarly, in the first medium period TM1 in the second large period TL2, the small period TS includes the pre-delay period TwA3, and in the second medium period TM2, the small period TS includes the pre-delay period TwA2.

The adjustment period Tadj following the second medium period TM2 is provided according to the lengths of the pre-delay period TwA and the shift period Tsft in order to unify the lengths of the large period TL.

A combination of the pre-delay period TwA provided in the first medium period TM1 included in the large period TL and the pre-delay period TwA provided in the second medium period TM2 may be selected in consideration of the length of the shift period Tsft.

For example, in a case where the length of the shift period Tsft is long, the length of the pre-delay period TwA provided in each medium period TM may be shortened.

Furthermore, by unifying the sum of the lengths of the pre-delay period TwA provided in the first medium period TM1, the pre-delay period TwA provided in the second medium period TM2, and the shift period Tsft for each large period TL, the adjustment period Tadj after the second medium period TM2 can be shortened or deleted, and the length of the large period TL can be shortened.

Note that, in the present modification, the example in which only the pre-delay period TwA is provided as the non-light receiving period Tb in the small period TS has been described. However, the present modification may be applied to a case where only the post-delay period TwB is provided as the non-light receiving period Tb in the small period TS.

Specifically, the length of the post-delay period TwB provided in the first medium period TM1 may be different from the length of the post-delay period TwB provided in the second medium period TM2.

### 4-7. Modification 7

The length of the shift period Tsft provided for each large period TL is not different for each large period TL but may be the same.

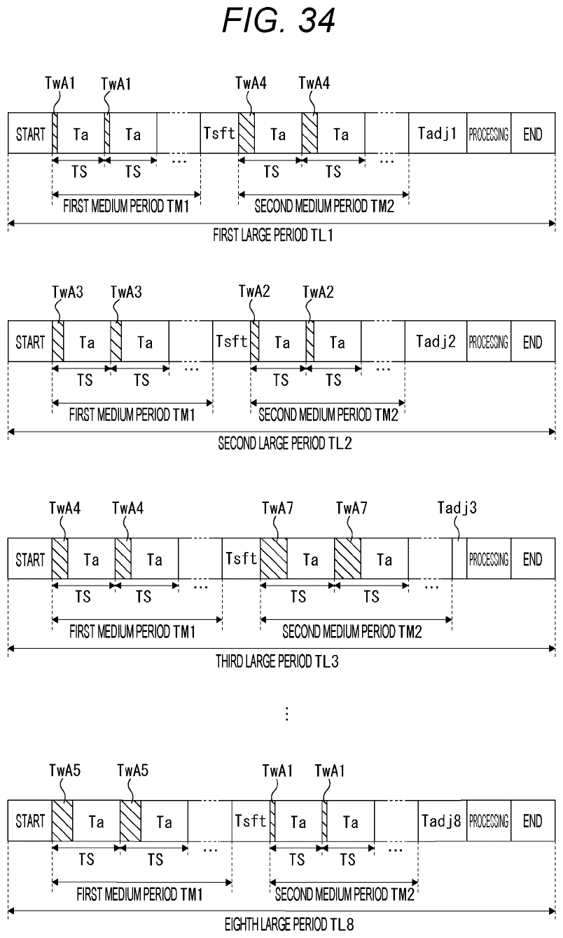

For example, in the example illustrated in FIG. 34, the large period TL includes two medium periods TM, and a shift period Tsft is provided between the two medium periods TM. Furthermore, an adjustment period Tadj is provided after the second medium period TM2.

The shift period Tsft provided between the medium periods TM has the same length in any large period. The pre-delay period TwA included in the small period TS in the first medium period TM1 and the pre-delay period TwA included in the small period TS in the second medium period TM2 have different lengths, and the lengths of the pre-delay periods TwA are different also in the comparison between the large periods TL.

By absorbing the difference in the length of the pre-delay period TwA in the comparison between the large periods TL in the adjustment period Tadj, the lengths of the large periods TL are unified.

By unifying the shift periods Tsft, it becomes unnecessary to perform processing of selecting the shift period Tsft from the plurality of shift periods, and the processing load can be reduced.

In FIG. 34, only the pre-delay period TwA is provided as the non-light receiving period Tb of the small period TS, but the period Tsft can be unified also in a case where only the post-delay period TwB is provided as the non-light receiving period Tb of the small period TS.

Note that, in the example illustrated in FIG. 34, the sum of the lengths of the first medium period TM1 and the second medium period TM2 may be the same for each large period TL. That is, in a case where the small period TS included in the first medium period TM1 is long, the small period TS included in the second medium period TM2 may be shortened accordingly. As a result, it is not necessary to provide the adjustment period Tadj for unifying the length of the large period TL.

Furthermore, in a case where the large period TL includes four medium periods TM, four kinds of lengths of pre-delay periods TwA are prepared, and the timing of the light receiving period Ta may be shifted for each large period TL by changing the combination of the four medium periods TM and the four kinds of pre-delay periods.

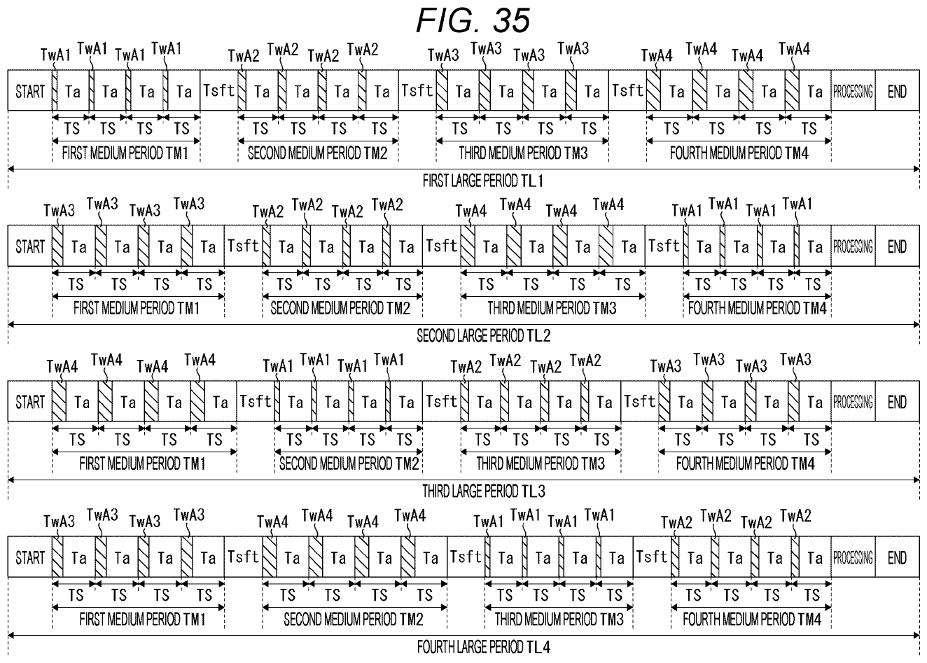

FIG. 35 specifically illustrates the configuration. A pre-delay period TwA1 is adopted in the first medium period TM1 in the first large period TL1, a pre-delay period TwA2 is adopted in the second medium period TM2, a pre-delay period TwA3 is adopted in the third medium period TM3, and a pre-delay period TwA4 is adopted in the fourth medium period TM4.

That is, in the first large period TL1, the same number (one by one) of the pre-delay periods TwA1, TwA2, TwA3, and TwA4 are included.

Then, even in the second large period TL2, the third large period TL3, and the fourth large period TL4, although the order is different, selection is performed such that the same number (one) of the pre-delay periods TwA1, TwA2, TwA3, and TwA4 are included.

As a result, the sum of the lengths of the first medium period TM1, the second medium period TM2, the third medium period TM3, and the fourth medium period TM4 is the same in any large period TL. Furthermore, since the lengths of the shift periods Tsft provided between the medium periods TM are the same, the lengths of the large periods TL can be unified without providing the adjustment period Tadj after the fourth medium period TM4.

As a result, the length of the large period TL can be shortened and the frame period can be shortened.

Note that, although FIG. 35 illustrates an example in which the combination of the medium period TM and the pre-delay period TwA is randomly changed for each large period TL, the combination may be fixed.

That is, the measurement in another second large period TL2 or third large period TL3 may be performed in the mode of the first large period TL1 illustrated in FIG. 35.

Furthermore, in FIG. 35, the pre-delay periods TwA1, TwA2, TwA3, and TwA4 are prepared and rearranged in a random order, and a round is made. However, the large period TL includes larger (for example, 8 or 12) medium periods TM, and the four types of pre-delay periods TwA may be repeatedly selected a plurality of times within the large period TL.

Note that, in a case where the pre-delay period TwA is randomly selected in the first medium period TM1 and the second medium period TM2, the pre-delay period TwA having the same length may be selected in the first medium period TM1 and the second medium period TM2 in one large period TL. In such a case, by providing the shift period Tsft between the medium periods TM, it is possible to avoid erroneous distance measurement due to detection of another light source.

### 4-8. Modification 8

In each of the examples described above, although there are differences in length, the configuration of the small period TS is the same regardless of the medium period TM. For example, in the example illustrated in FIG. 30, both the pre-delay period TwA and the post-delay period TwB are included in addition to the light receiving period Ta in any small period TS, and in the example illustrated in FIG. 31, only the pre-delay period TwA is included in addition to the light receiving period Ta in any small period TS.

In the present modification, a part of the small period TS includes only the light receiving period Ta.

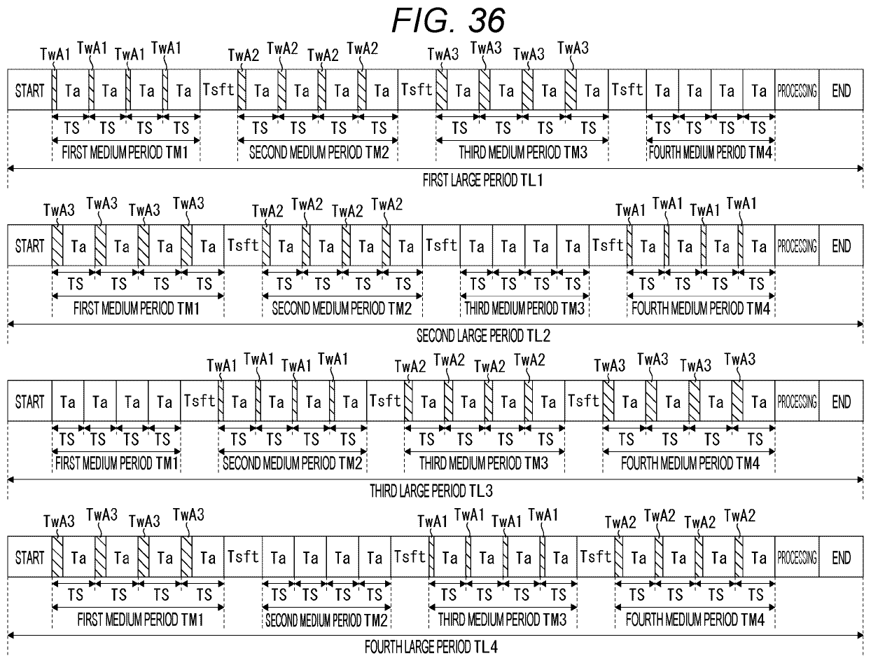

For example, FIG. 36 is a modification of the example illustrated in FIG. 35. In the example illustrated in FIG. 35, one is selected for each medium period TM from the four types of pre-delay periods TwA1, TwA2, TwA3, and TwA4, but in the example illustrated in FIG. 36, one is selected for each medium period TM from four options of three types of pre-delay periods TwA1, TwA2, and TwA3 and no pre-delay period TwA (It can also be understood that a pre-delay period TwA having a length of 0 is provided).

In a case where the pre-delay period TwA and the post-delay period TwB are changed for each medium period TM, an option of not providing the delay period may be prepared as one of the options.

As a result, the length of the large period TL can be shortened.

### 4-9. Modification 9

Unlike the above-described examples, the shift period Tsft may include a processing period (“processing” in each drawing), and a first non-processing period TnpA and a second non-processing period TnpB provided before and after the processing period. That is, storage processing in a memory and the like may be appropriately performed in the processing period of the shift period Tsft provided for each medium period TM.

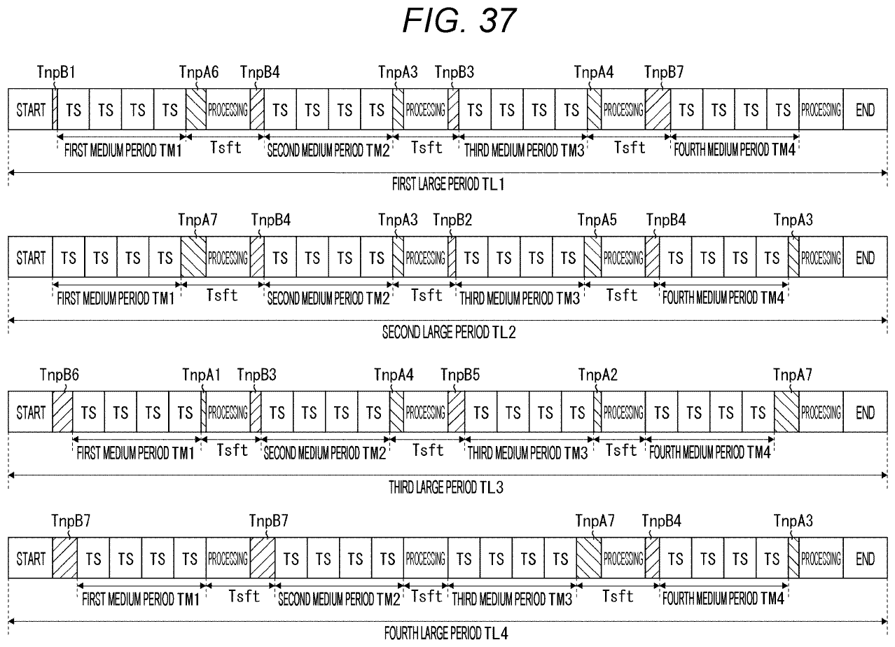

FIG. 37 specifically illustrates the configuration.

In the first large period TL1, four medium periods are provided, and a shift period Tsft is provided between the respective medium periods TM.

The shift period Tsft includes a processing period (“processing” in the drawing), a first non-processing period TnpA, and a second non-processing period TnpB.

Furthermore, the second non-processing period TnpB is provided before the first medium period TM1, and the start timing of the first small period TS for each large period TL varies.

Considering the medium period TM including the four small periods TS as a reference, the second non-processing period TnpB is provided ahead of the medium period TM, and the first non-processing period TnpA is provided behind the medium period TM.

As the first non-processing period TnpA, a total of eight types including an option having a length of 0 (that is, an option of not providing the first non-processing period TnpA) and a first non-processing period InpA1 having a short length to a first non-processing period TnpA7 having a long length are prepared. Furthermore, correspondingly, as the second non-processing period TnpB, a total of eight types of a second non-processing period TnpB1 having a short length from the second non-processing period TnpB7 having a long length and an option having a length of 0 (that is, an option of not providing the second non-processing period TnpB) are prepared.

The second non-processing period TnpB and the first non-processing period TnpA before and after the medium period TM are selected so that the total lengths thereof coincide with each other, whereby the lengths of the large periods TL are unified without providing the adjustment period Tadj after the fourth medium period TM4.

Furthermore, since the total length of the medium period TM, the second non-processing period TnpB before and after the medium period TM, and the first non-processing period TnpA matches, the position of the processing period with respect to the start period (“start” in the drawing) is unchanged for each large period TL.

Therefore, the example illustrated in FIG. 37 can be said to be an example in which the processing executed in the processing period within the large period TL is periodically executed.

Note that, depending on the selection mode of the first non-processing period TnpA and the second non-processing period TnpB, the shift period Tsft may be configured to include only the processing period like the shift period Tsft provided between the second medium period TM2 and the third medium period TM3 of the fourth large period TL4 illustrated in FIG. 37.

In the present modification, the selection processing of the second non-processing period TnpB and the first non-processing period TnpA can be executed in a processing period provided after the medium period TM. Therefore, since it is not necessary to execute processing of selecting the length of each period in advance before the start of the large period TL, the large period TL can be started quickly.

Note that the order may be selected in advance such that four types of the first non-processing periods TnpA and four types of the second non-processing periods TnpB (which may include those having a length of 0) are prepared, and each of the four types of the first non-processing periods TnpA and the four types of the second non-processing periods TnpB appear one by one in random order in one large period TL.

Furthermore, the configuration of the first large period TL1 obtained by randomly disposing the first non-processing period TnpA and the second non-processing period TnpB before and after the medium period TM may be repeated in the second large period TL2 and the third large period TL3. For example, in the second large period TL2, the third large period TL3, and the fourth large period TL4 illustrated in FIG. 37, the measurement may be repeated at the similar timing to the first large period TL1.

In this case, the processing of randomly disposing the first non-processing period TnpA and the second non-processing period TnpB only needs to be performed once, so that the processing load can be reduced.

Note that, although FIG. 37 illustrates an example in which all the shift periods Tsft can include both the first non-processing period TnpA and the second non-processing period TnpB, the shift period Tsft may not include any one of the first non-processing period TnpA and the second non-processing period TnpB.

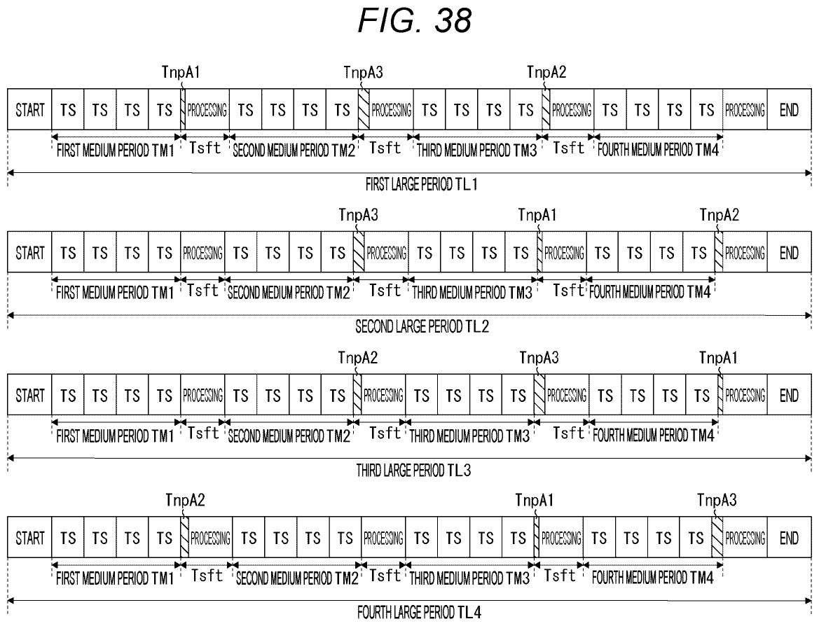

For example, FIG. 38 illustrates an example in which each shift period Tsft does not include the second non-processing period TnpB.

In this case, the position of the processing period with respect to the start period is not constant. Therefore, the example illustrated in FIG. 38 can be said to be an example in which the processing executed in the processing period within the large period TL is executed aperiodically.

### 4-10. Modification 10

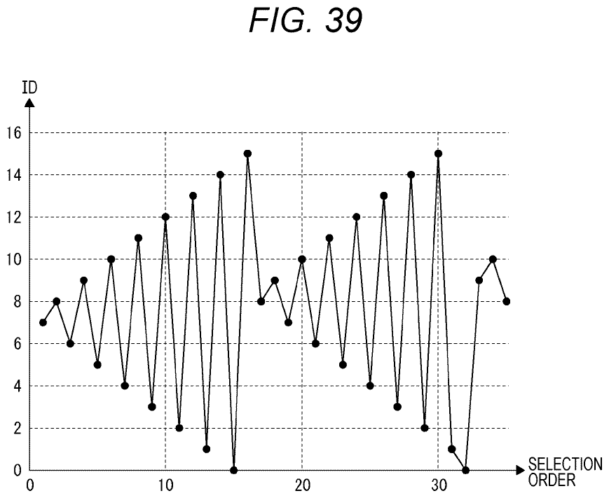

Various modes of selecting the length of the shift period Tsft can be considered. An example is illustrated in FIG. 39.

First, a plurality of shift periods Tsft having different lengths are prepared (16 types in FIG. 39), and a shift period ID (identification) is assigned in order from a shorter one.

Then, an initial value of the shift period ID is selected (“7” in FIG. 39), and the shift period ID is sequentially selected by repeating increment and decrement from the initial value. At this time, the variation range is increased each time increment and decrement are repeated.

Specifically, after “7” is selected as the shift period ID, 1 is added to select “8” as the shift period ID, and then 2 is subtracted to select “6” as the shift period ID. Then, 3 is added to select “9” as the shift period ID.

In a case where the calculated shift period ID is out of the range (other than 0 to 15), the shift period ID is returned to the initial value again.

Note that, at this time, as illustrated in FIG. 39, the initial value of the shift period ID may be changed (for example, changed from “7” to “8”).

By selecting the shift period ID in such a manner that it is difficult to estimate the shift period ID, it is possible to make it difficult to estimate the light emission timing in the small period TS, and it is possible to make it difficult to hinder distance measurement by interference light.

Note that, although the selection mode of the length of the shift period Tsft has been described here, a similar mode may be applied to the length of other various periods such as the length of the pre-delay period TwA and the length of the post-delay period TwB.

### 5. Other Modifications

The another light source detection may be executed in the ToF sensor 12 before the first medium period data and the second medium period data are transmitted. Then, the ToF sensor 12 may store information on a result of the another light source detection in the payload area of the MIPI data.

The information on the result of the another light source detection may be, for example, 1-bit data indicating whether or not the another light source has been detected. Alternatively, the data may be 1-bit data indicating whether or not light reception data for the another light source has been excluded.

Alternatively, it may be data in which information indicating the influence on the calculation of the distance measurement data due to reception of light from the another light source is expressed by, for example, two bits. In the 2-bit data, for example, “00” may indicate that the influence of the another light source is small, “01” may indicate that the influence of the another light source is moderate, “10” may indicate that the influence of the another light source is large, and “11” may indicate that the presence or absence of the another light source cannot be determined. Note that these are merely examples, and information indicating the influence on the another light source may be stored in the payload area of the MIPI data in other modes.

In each of the examples described above, the shift period Tsft is provided between the medium periods TM, but the pre-delay period TwA and the post-delay period TwB included in the small period TS may be substituted without providing the shift period Tsft.

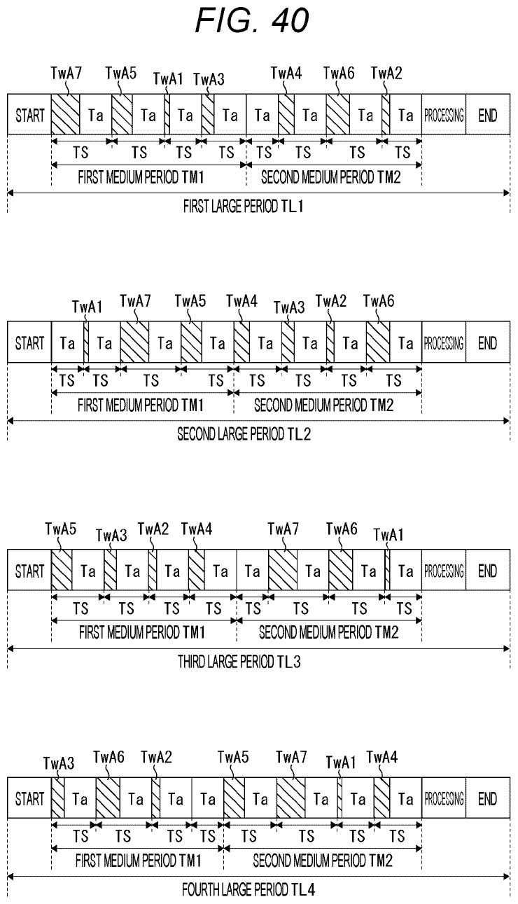

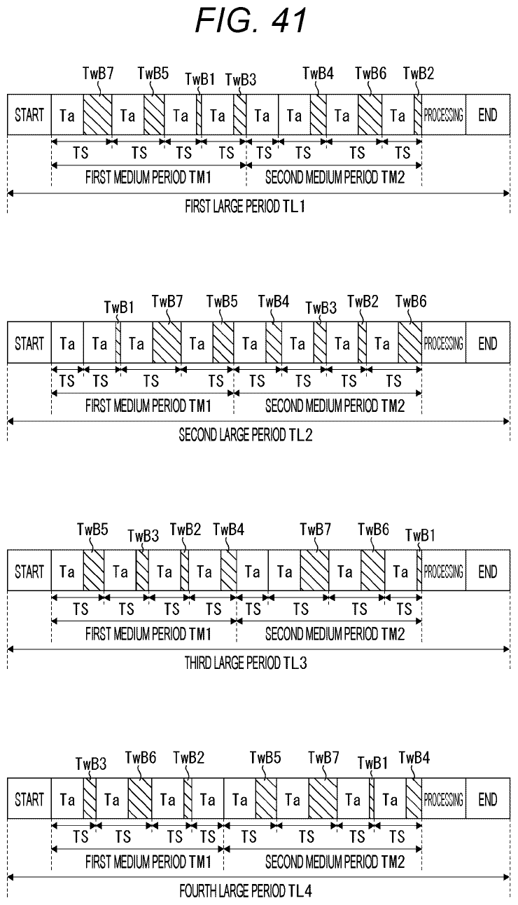

This will be specifically described with reference to FIGS. 40 and 41.

In the example illustrated in FIG. 40, the large period TL includes two medium periods TM, and one medium period TM includes four small periods TS. Then, one small period TS includes a pre-delay period TwA and a light receiving period Ta.

As the pre-delay period TwA, eight kinds (one of which has a length of 0) having different lengths are prepared, rearranged in a predetermined order using a random number, a pseudo random number, or the like, and then combined with eight small periods TS included in the large period TL.

As a result, since any of the pre-delay periods TwA is provided between the last light receiving period Ta in the first medium period TM1 and the first light receiving period Ta in the second medium period TM2, it is possible to shift the light emission timing in the first medium period TM1 and the light emission timing in the second medium period TM2.

As a result, even in the configuration illustrated in FIG. 40, it is possible to make it difficult to hinder distance measurement by interference light.

Then, as illustrated in FIG. 40, the difficulty of interference can be further enhanced by changing the order of the eight types of pre-delay periods TwA for each large period TL.

In the example illustrated in FIG. 41, the post-delay period TwB is used instead of the pre-delay period TwA in the example illustrated in FIG. 40.

Even with such a configuration, a similar effect can be obtained.

Furthermore, although a plurality of types of the pre-delay periods TwA are prepared in FIG. 40, only one type of the pre-delay period TwA having a predetermined length may be prepared. Then, it may be selected whether or not to include the pre-delay period TwA in each small period TS. As a result, the small period TS including only the light receiving period Ta, the pre-delay period TwA, and the small period TS including the light receiving period Ta are irregularly mixed to form the medium period TM. Even with such a configuration, it is possible to make it difficult to hinder distance measurement by interference light.

Such a configuration can also be applied to the post-delay period TwB in FIG. 41.

Each example described above is not limited to the ToF sensor 12 (12A, 12B) as one chip in which a pixel array unit and a processing unit such as a CPU are stacked, and can be applied to a light receiving device in which the pixel array unit and the CPU are provided as separate different chips.

### 6. Summary

As described in each of the examples described above, the ToF sensor 12 (12A, 12B) as a light receiving device includes the light receiving unit 4 that receives the reflected light in which the light emitted from the light emitting unit 3 (3A, 3B) according to the light emission instruction issued on the basis of the predetermined processing cycle (cycle of the start timing of the small period TS) is reflected by the subject OB, and the calculation unit (intermediate data calculation unit 13) that calculates the information (unit distance data as intermediate data, data on a histogram, or distance data) regarding the distance to the subject OB according to the difference between the light emission timing of the light emitting unit 3 and the light reception timing of the light receiving unit 4, in which the light emission instruction is issued at a timing delayed by a shift period Tsft with respect to a reference timing in each cycle of the predetermined processing cycle for each medium period TM including a plurality of small periods TS each including one time of light emission, and a ratio of the shift period Tsft to each of the small periods TS is changed for each large period TL including a plurality of the medium periods TM. By providing the shift period Tsft for each medium period TM in which the small periods TS continue, the periodicity of the light emission timing can be disturbed, and thus it is possible to prevent erroneous distance data (or information regarding the distance) from being calculated on the basis of mixing, interference, or the like of another light source or the like. Furthermore, interference of distance measurement by interference light can be made difficult.

As described with reference to FIG. 14 and the like, the ToF sensor 12 (12A, 12B) as the light receiving device may include the transmission unit (communication unit 14) that transmits the information regarding the distance (unit distance data as intermediate data, data on a histogram, or distance data) and the information for ensuring the integrity of at least a part of the information regarding the distance.

The information for protecting the integrity is, for example, a CRC value, a MAC value, or the like.

By transmitting such information together with the information regarding the distance, the calculation of the distance data and the processing using the distance data can be appropriately performed in the subsequent stage on the basis of the correct information.

As described with reference to FIG. 14 and the like, in the ToF sensor 12 (12A, 12B) as the light receiving device, the large period TL may include the first medium period TM1 and the second medium period TM2 as the medium period TM, the information regarding the distance may be intermediate data for calculating the distance data, and the transmission unit (the communication unit 14) that transmits first data (for example, the packet data illustrated in FIG. 14 and the like) in which the intermediate data of the first medium period TM1 is stored in a payload area and second data (for example, the packet data illustrated in FIG. 14 and the like) in which the intermediate data of the second medium period TM2 is stored in a payload area may be included.

The transmission unit transmits the first data and the second data to a device such as the distance calculation unit 5, so that the device can calculate appropriate distance data in consideration of another light source.

As described with reference to FIG. 17 and the like, in the ToF sensor 12 (12A, 12B) as the light receiving device, the large period TL may include the first medium period TM1 and the second medium period TM2 as the medium period TM, the information regarding the distance may be intermediate data for calculating the distance data, and the transmission unit (the communication unit 14) that transmits data in which both the intermediate data of the first medium period TM1 and the intermediate data of the second medium period TM2 are stored in a payload area may be included.

In order to obtain information on the another light source, both the intermediate data for the first medium period TM1 and the intermediate data for the second medium period TM2 are required. According to this configuration, since the first medium period data and the second medium period data are stored as a set in one data and transmitted, processing of detecting noise by another light source in the subsequent stage is facilitated, and a processing load is reduced.

As described with reference to FIG. 25 and the like, in the ToF sensor 12 (12A, 12B) as the light receiving device, the large period TL includes three or more of the medium periods TM and two or more of the shift periods Tsft provided between the medium periods TM, and a plurality of the shift periods Tsft included in one large period TL may have the same time length.

As a result, it is not necessary to perform processing of selecting the shift period Tsft for each medium period TM in the large period TL a plurality of times, and the processing load can be reduced.

As described with reference to FIGS. 26, 27, 28, 29, 37, 38, and the like, in the ToF sensor 12 (12A, 12B) as the light receiving device, the large period TL may include three or more of the medium periods TM and two or more of the shift periods Tsft provided between the medium periods TM, and a plurality of the shift periods Tsft included in one large period TL may have at least partially different time lengths.

As a result, since the light emission timing can be appropriately shifted for each medium period TM, the another light source can be more reliably detected.

As described with reference to FIG. 29 and the like, in the ToF sensor 12 (12A, 12B) as the light receiving device, the sum of the shift periods Tsft included in the large period TL may be the same time length for each large period TL.

As a result, the length of the large period TL can be unified without providing the adjustment period Tadj. Then, by not providing the adjustment period Tadj, the length of the large period TL can be shortened or the processing period can be extended.

As described with reference to each of FIGS. 31 to 36, in the ToF sensor 12 (12A, 12B) as the light receiving device, each of the small periods TS includes the light receiving period Ta and the non-light receiving period Tb provided at least one of before and after the light receiving period Ta, and the time length of the small period TS may be changed every large period TL.

As a result, the cycle of the small period TS in the medium period TM can be made different for each large period TL, and interference of distance measurement by interference light can be made difficult.

As described with reference to each of FIGS. 33 to 36, in the ToF sensor 12 (12A, 12B) as the light receiving device, the time lengths of the plurality of small periods TS included in the same large period TL may be at least partially different.

For example, the small period TS may be changed for each medium period TM within the large period TL. As a result, since the cycle of the small period TS changes every medium period, it is possible to make it difficult to hinder distance measurement by interference light.

As described with reference to FIGS. 35, 36, and the like, in the ToF sensor 12 (12A, 12B) as the light receiving device, the sum of the time lengths of the plurality of small periods TS included in the large period TL may be the same time length for each large period TL.

As illustrated in FIG. 13, not only in a case where the small period TS includes only the light receiving period Ta, but also in a case where the small period TS includes the pre-delay period TwA (see FIG. 35) and the post-delay period TwB (see FIG. 36) as the non-light receiving period Tb, the total length of the small periods TS in the large period TL can be unified.

As a result, the cycle of the small period TS changes every medium period, making it difficult to interfere with distance measurement, and making it possible to shorten the length of the large period TL. Therefore, the frame rate can be set to a high frequency.

As described with reference to each of FIGS. 31 to 36, in the ToF sensor 12 (12A, 12B) as the light receiving device, each of the small periods TS may include the light receiving period Ta and the non-light receiving period Tb provided at least one of before and after the light receiving period Ta, and the time length of the non-light receiving period Tb may be changed every large period TL.

As a result, the light emission timing of the light emitting unit 3 can be shifted every large period TL, and interference of distance measurement can be made difficult.

As described with reference to each of FIGS. 33 to 36, in the ToF sensor 12 (12A, 12B) as the light receiving device, the time lengths of a plurality of the non-light receiving periods Tb included in the same large period TL may be at least partially different.

As a result, the light emission timing of the light emitting unit 3 can be made aperiodic even within the large period TL, and resistance to interference by interference light can be enhanced.

As described with reference to FIGS. 30, 35, 36, and the like, in the ToF sensor 12 (12A, 12B) as the light receiving device, the sum of the time lengths of the plurality of non-light receiving periods Tb included in the large period TL may have the same time length for each large period TL.

As illustrated in FIG. 37, in the ToF sensor 12 (12A, 12B) as the light receiving device, the large period TL may include a processing period (a period described as “processing” in each drawing) in which processing different from the processing executed in each of the small periods TS is executed, the processing period may be periodically provided, and the shift period Tsft may include at least a part of the processing period.

By setting the execution timing of the processing to be periodic, it is possible to prevent concentration of the processing.

As described with reference to FIG. 2 and the like, the ToF sensor 12 (12A, 12B) as the light receiving device may include the delay amount instruction unit 7 that reflects the time length of the shift period Tsft as the delay amount (second delay amount) in the light emission instruction.

Specifically, the delay amount instruction unit 7 determines the amount (second delay amount) by which the small period TS is delayed by determining the length of the shift period Tsft. Then, by supplying the delay amount to the counter unit 6, the counter value is reset to “0”.

The counter unit 6 supplies a start timing of the small period TS to the light emission instruction unit 8 at the time of resetting. As a result, the delay amount instruction unit 7 can indirectly delay the light emission instruction according to the length of the shift period Tsft.

Therefore, the light emission timing can be made difficult to recognize from the outside, and the resistance to the interference light can be improved.

As described with reference to the drawings, the ToF sensor 12A as an information processing device or the distance calculation unit 5 may include the another light source detection unit 17 that detects noise based on light emission of another light source other than the light emitting unit 3 on the basis of the information (unit distance data as intermediate data, data on a histogram, or distance data) regarding the distance to the subject OB calculated according to the difference between the light emission timing of the light emitted from the light emitting unit 3 (3A, 3B) by the light emission instruction issued on the basis of the predetermined processing cycle and the light reception timing of receiving reflected light obtained by reflecting the light on the subject OB. The light emission instruction may be issued at timing delayed by the shift period Tsft with respect to the reference timing in each cycle of the predetermined processing cycle for each medium period TM including a plurality of small periods TS each including one time of light emission, and the ratio of the shift period Tsft to each of the small periods TS may be changed for each large period TL including a plurality of the medium periods TM.

By providing the shift period Tsft for each medium period TM in which the small periods TS continue, the periodicity of the light emission timing can be disturbed, and thus it is possible to prevent erroneous distance data (or information regarding the distance) from being calculated on the basis of mixing, interference, or the like of another light source or the like. Furthermore, interference of distance measurement by interference light can be made difficult.

As described with reference to each of FIGS. 10 to 12, in the ToF sensor 12A as the information processing device or the distance calculation unit 5, the large period TL may include the first medium period TM1 and the second medium period TM2 as the medium period TM, the information regarding the distance may be intermediate data for calculating the distance data, and the another light source detection unit 17 may detect the noise on the basis of the comparison result between the intermediate data of the first medium period TM1 and the intermediate data of the second medium period TM2.

Specifically, it can be realized by generating each histogram on the basis of the unit distance data acquired in the first medium period TM1 and the unit distance data acquired in the second medium period TM2.

As a result, the another light source can be suitably detected.

As described with reference to FIG. 23 and the like, the ToF sensor 12A as the information processing device may include the transmission unit (communication unit 14) that transmits information regarding the another light source.

For example, by generating information regarding the another light source in the ToF sensor 12A, in the sensor,

As described in each of the examples described above, the distance measuring system 1 (1A, 1B) as a distance measuring device includes: the light receiving unit 4 that receives reflected light in which light emitted from the light emitting unit 3 (3A, 3B) according to a light emission instruction issued on the basis of a predetermined processing cycle is reflected by the subject OB; and the calculation unit (intermediate data calculation unit 13) that calculates distance data to the subject OB according to a difference between a light emission timing of the light emitting unit 3 and a light reception timing of the light receiving unit 4, in which the light emission instruction is issued at a timing delayed by the shift period Tsft with respect to a reference timing in each cycle of the predetermined processing cycle for each medium period TM including a plurality of small periods TS each including one time of light emission, and a ratio of the shift period Tsft to each of the small periods TS is changed for each large period TL including a plurality of the medium periods TM.

By providing the shift period Tsft for each medium period TM in which the small periods TS continue, the periodicity of the light emission timing can be disturbed, and thus it is possible to prevent erroneous distance data (or information regarding the distance) from being calculated on the basis of mixing, interference, or the like of another light source or the like. Furthermore, interference of distance measurement by interference light can be made difficult.

An information processing method according to the embodiment is an information processing method executed by an information processing device, the information processing method including: for light that is emitted from a light emitting unit 3 (3A, 3B) according to a light emission instruction issued on the basis of a predetermined processing cycle and in which information regarding a distance to a subject OB is calculated according to a difference between a light reception timing by the light receiving unit 4 that receives reflected light obtained by the light being reflected by the subject OB and a light emission timing of the light emitting unit 3, issuing the light emission instruction at a timing delayed by a shift period Tsft with respect to a reference timing in each cycle of the predetermined processing cycle for each medium period TM including a plurality of small periods TS each including one time of light emission; and changing a ratio of the shift period Tsft to each of the small periods TS for each large period TL including a plurality of the medium periods TM.

Also by such an information processing method, it is possible to obtain the similar actions and effects to those of the ToF sensor 12 (12A, 12B) as each of the above-described embodiments and modifications.

Note that, the effects described in the present specification are merely examples and are not limited, and other effects may be provided.

Furthermore, the above-described examples may be combined in any way, and the above-described various functions and effects may be obtained even in a case where various combinations are used.

The timings and positions of the respective elements illustrated in the block diagrams and flowcharts illustrated in the respective drawings are merely examples, and may be configured to be different at least partially.

The embodiments described in each example has various modifications. That is, in the constituent elements of each example described, a part may be the same, a part may be integrated, a part may be integrated, or a part may be separate. Furthermore, in the constituent elements of each of the described examples, some of the constituent elements may be omitted, some or all of the constituent elements may be changed, or some or all of the constituent elements may be changed. Furthermore, in the constituent elements of each example described, a part may be replaced with another constituent element, or another constituent element may be added to a part or all of the components. Moreover, in the constituent elements of each of the described examples, a part or all of the constituent elements may be divided into a plurality of constituent elements, a part or all of the constituent elements may be separated into a plurality of constituent elements, or at least one of functions and features may be made different in at least a part of the plurality of divided or separated constituent elements.

Furthermore, at least some of the constituent elements may be moved to form different embodiments. Moreover, at least one of a coupling element and a relay element may be added to a combination of at least some of the constituent elements to form a different embodiment. In addition, at least one of a switching function and a selection function may be added to a combination of at least some of the constituent elements to form a different embodiment.

Herein, in this specification, the processing performed by the computer according to the program is not necessarily required to be performed in time series along the order described as the flowchart. In other words, the processing to be performed by the computer in accordance with the program include processing to be executed in parallel or independently (for example, parallel processing or object-based processing).

Furthermore, the program may be processed by one computer (processor) or may be processed in a distributed manner by a plurality of computers. Moreover, the program may be transmitted to a remote computer to be executed.

Moreover, in the present description, a system means a set of a plurality of constituent elements (devices, modules (parts), and the like), and it does not matter whether or not all the constituent elements are in the same housing. Therefore, a plurality of devices accommodated in separate housings and connected via a network and one device in which a plurality of modules is accommodated in one housing are both systems.

Furthermore, for example, a configuration described as one device (or processing unit) may be divided and configured as a plurality of devices (or processing units). Conversely, configurations described above as a plurality of devices (or processing units) may be collectively configured as one device (or processing unit). Furthermore, it goes without saying that a configuration other than the above-described configurations may be added to the configuration of each device (or each processing unit). Moreover, if the configuration and operation of the entire system are substantially the same, a part of the configuration of a certain device (or processing unit) may be included in the configuration of another device (or another processing unit).

Furthermore, for example, the present technology can have a configuration of cloud computing in which one function is shared and processed by a plurality of devices in cooperation via a network.

Furthermore, for example, the program described above can be executed by an optional device. In this case, the device is only required to have a necessary function (functional block or the like) and obtain necessary information.

Furthermore, for example, each step described in the above-described flowchart can be executed by one device or can be shared and executed by a plurality of devices. Moreover, in a case where a plurality of processing is included in one step, the plurality of processing included in the one step can be executed by one device or can be shared and executed by a plurality of devices. In other words, a plurality of processing included in one step can also be executed as processing of a plurality of steps. Conversely, the processing described as a plurality of steps can be collectively executed as one step.

Note that, in the program executed by the computer, processing of steps describing the program may be executed in time series in the order described in the present specification, or may be executed in parallel or individually at necessary timing such as when a call is made. That is, the pieces of processing of the respective steps may be executed in an order different from the above-described order as long as there is no contradiction. Moreover, the processing of steps describing this program may be executed in parallel with the processing of another program, or may be executed in combination with the processing of another program.

Note that, the plurality of present technologies that has been described in the present specification can each be implemented independently as a single unit unless there is a contradiction. It goes without saying that any plurality of present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

### 7. Present Technology

Note that the present technology can also have the following configurations.
(1)

A light receiving device including:
a light receiving unit that receives reflected light in which light emitted from a light emitting unit according to a light emission instruction issued on the basis of a predetermined processing cycle is reflected by a subject; and
a calculation unit that calculates information regarding a distance to the subject according to a difference between a light emission timing of the light emitting unit and a light reception timing of the light receiving unit,
in which the light emission instruction is issued at a timing delayed by a shift period with respect to a reference timing in each cycle of the predetermined processing cycle for each medium period including a plurality of small periods each including one time of light emission, and
a ratio of the shift period to each of the small periods is changed for each large period including a plurality of the medium periods.
(2)

The light receiving device according to (1) described above, further including
a transmission unit that transmits the information regarding the distance and information for ensuring integrity of at least a part of the information regarding the distance.
(3)

The light receiving device according to any one of (1) described above to (2) described above, in which
the large period includes a first medium period and a second medium period as the medium period,
the information regarding the distance is intermediate data for calculating distance data, and
the light receiving device further includes a transmission unit that transmits first data in which the intermediate data of the first medium period is stored in a payload area and second data in which the intermediate data of the second medium period is stored in a payload area.
(4)

The light receiving device according to any one of (1) described above to (2) described above, in which
the large period includes a first medium period and a second medium period as the medium period,
the information regarding the distance is intermediate data for calculating distance data, and
the light receiving device further includes a transmission unit that transmits data in which both the intermediate data of the first medium period and the intermediate data of the second medium period are stored in a payload area.
(5)

The light receiving device according to any one of (1) described above to (4) described above, in which
the large period includes three or more of the medium periods and two or more of the shift periods provided between the medium periods, and
a plurality of the shift periods included in one large period has a same time length.
(6)

The light receiving device according to any one of (1) described above to (4) described above, in which
the large period includes three or more of the medium periods and two or more of the shift periods provided between the medium periods, and
a plurality of the shift periods included in one large period has at least partially different time lengths.
(7)

The light receiving device according to (6) described above, in which
a sum of the shift periods included in the large period has a same time length for each large period.
(8)

The light receiving device according to any one of (1) described above to (7) described above, in which
each of the small periods includes a light receiving period and a non-light receiving period provided at least one of before and after the light receiving period, and
a time length of the small period is changed every large period.
(9)

The light receiving device according to (8) described above, in which
time lengths of the plurality of small periods included in a same large period are at least partially different.
(10)

The light receiving device according to (9) described above, in which
a sum of time lengths of the plurality of small periods included in the large period has a same time length for each large period.
(11)

The light receiving device according to any one of (1) described above to (10) described above, in which
each of the small periods includes a light receiving period and a non-light receiving period provided at least one of before and after the light receiving period, and
a time length of the non-light receiving period is changed every large period.
(12)

The light receiving device according to (11) described above, in which
time lengths of a plurality of the non-light receiving periods included in a same large period are at least partially different.
(13)

The light receiving device according to (12) described above, in which
a sum of time lengths of the plurality of non-light receiving periods included in the large period has a same time length for each large period.
(14)

The light receiving device according to any one of (1) described above to (13) described above, in which
the large period includes a processing period in which processing different from processing executed in each of the small periods is executed,
the processing period is periodically provided, and
the shift period includes at least a part of the processing period.
(15)

The light receiving device according to any one of (1) described above to (14) described above, further including
a delay amount instruction unit that reflects a time length of the shift period as a delay amount in the light emission instruction.
(16)

An information processing device including:
another light source detection unit that detects noise based on light emission of another light source other than a light emitting unit on the basis of information regarding a distance to a subject calculated according to a difference between a light emission timing of light emitted from the light emitting unit by a light emission instruction issued on the basis of a predetermined processing cycle and a light reception timing of receiving reflected light obtained by reflecting the light on the subject,
in which the light emission instruction is issued at a timing delayed by a shift period with respect to a reference timing in each cycle of the predetermined processing cycle for each medium period including a plurality of small periods each including one time of light emission, and
a ratio of the shift period to each of the small periods is changed for each large period including a plurality of the medium periods.
(17)

The information processing device according to (16) described above, in which
the large period includes a first medium period and a second medium period as the medium period,
the information regarding the distance is intermediate data for calculating distance data, and
the another light source detection unit detects the noise on the basis of a comparison result between the intermediate data of the first medium period and the intermediate data of the second medium period.
(18)

The information processing device according to any one of (16) described above to (17) described above, further including
a transmission unit that transmits information regarding the another light source.
(19)

A distance measuring device including:
a light receiving unit that receives reflected light in which light emitted from a light emitting unit according to a light emission instruction issued on the basis of a predetermined processing cycle is reflected by a subject; and a calculation unit that calculates distance data to the subject according to a difference between a light emission timing of the light emitting unit and a light reception timing of the light receiving unit,
in which the light emission instruction is issued at a timing delayed by a shift period with respect to a reference timing in each cycle of the predetermined processing cycle for each medium period including a plurality of small periods each including one time of light emission, and
a ratio of the shift period to each of the small periods is changed for each large period including a plurality of the medium periods.
(20)

An information processing method including:
for light that is emitted from a light emitting unit according to a light emission instruction issued on the basis of a predetermined processing cycle and in which information regarding a distance to a subject is calculated according to a difference between a light reception timing by the light receiving unit that receives reflected light obtained by the light being reflected by the subject and a light emission timing of the light emitting unit,
issuing the light emission instruction at a timing delayed by a shift period with respect to a reference timing in each cycle of the predetermined processing cycle for each medium period including a plurality of small periods each including one time of light emission; and
changing a ratio of the shift period to each of the small periods for each large period including a plurality of the medium periods.

### REFERENCE SIGNS LIST

1, 1A, 1B Distance measuring system (distance measuring device)
3, 3A, 3B Light emitting unit
4 Light receiving unit
7 Delay amount instruction unit
13 Intermediate data calculation unit (calculation unit)
14 Communication unit (transmission unit)
17 Another light source detection unit
OB Subject
TS Small period
TM Medium period
TM1 First medium period
TM2 Second medium period
TM3 Third medium period
TM4 Fourth medium period
TL Large period
TL1 First large period
TL2 Second large period
TL3 Third large period
TL8 Eighth large period
Tsft Shift period
Ta Light receiving period
Tb Non-light receiving period

What is claimed is:

1. A light receiving device comprising:
a light receiving unit that receives reflected light in which light emitted from a light emitting unit according to a light emission instruction issued on a basis of a predetermined processing cycle is reflected by a subject; and
a calculation unit that calculates information regarding a distance to the subject according to a difference between a light emission timing of the light emitting unit and a light reception timing of the light receiving unit,
wherein the light emission instruction is issued at a timing delayed by a shift period with respect to a reference timing in each cycle of the predetermined processing cycle for each medium period including a plurality of small periods each including one time of light emission, and
a ratio of the shift period to each of the small periods is changed for each large period including a plurality of the medium periods.

2. The light receiving device according to claim 1, further comprising
a transmission unit that transmits the information regarding the distance and information for ensuring integrity of at least a part of the information regarding the distance.

3. The light receiving device according to claim 1, wherein
the large period includes a first medium period and a second medium period as the medium period,
the information regarding the distance is intermediate data for calculating distance data, and
the light receiving device further includes a transmission unit that transmits first data in which the intermediate data of the first medium period is stored in a payload area and second data in which the intermediate data of the second medium period is stored in a payload area.

4. The light receiving device according to claim 1, wherein
the large period includes a first medium period and a second medium period as the medium period,
the information regarding the distance is intermediate data for calculating distance data, and
the light receiving device further includes a transmission unit that transmits data in which both the intermediate data of the first medium period and the intermediate data of the second medium period are stored in a payload area.

5. The light receiving device according to claim 1, wherein
the large period includes three or more of the medium periods and two or more of the shift periods provided between the medium periods, and
a plurality of the shift periods included in one large period has a same time length.

6. The light receiving device according to claim 1, wherein
the large period includes three or more of the medium periods and two or more of the shift periods provided between the medium periods, and
a plurality of the shift periods included in one large period has at least partially different time lengths.

7. The light receiving device according to claim 6, wherein
a sum of the shift periods included in the large period has a same time length for each large period.

8. The light receiving device according to claim 1, wherein
each of the small periods includes a light receiving period and a non-light receiving period provided at least one of before and after the light receiving period, and
a time length of the small period is changed every large period.

9. The light receiving device according to claim 8, wherein
time lengths of the plurality of small periods included in a same large period are at least partially different.

10. The light receiving device according to claim 9, wherein
a sum of time lengths of the plurality of small periods included in the large period has a same time length for each large period.

11. The light receiving device according to claim 1, wherein
each of the small periods includes a light receiving period and a non-light receiving period provided at least one of before and after the light receiving period, and
a time length of the non-light receiving period is changed every large period.

12. The light receiving device according to claim 11, wherein
time lengths of a plurality of the non-light receiving periods included in a same large period are at least partially different.

13. The light receiving device according to claim 12, wherein
a sum of time lengths of the plurality of non-light receiving periods included in the large period has a same time length for each large period.

14. The light receiving device according to claim 1, wherein
the large period includes a processing period in which processing different from processing executed in each of the small periods is executed,
the processing period is periodically provided, and
the shift period includes at least a part of the processing period.

15. The light receiving device according to claim 1, further comprising
a delay amount instruction unit that reflects a time length of the shift period as a delay amount in the light emission instruction.

16. An information processing devices comprising
another light source detection unit that detects noise based on light emission of another light source other than a light emitting unit on a basis of information regarding a distance to a subject calculated according to a difference between a light emission timing of light emitted from the light emitting unit by a light emission instruction issued on a basis of a predetermined processing cycle and a light reception timing of receiving reflected light obtained by reflecting the light on the subject,
wherein the light emission instruction is issued at a timing delayed by a shift period with respect to a reference timing in each cycle of the predetermined processing cycle for each medium period including a plurality of small periods each including one time of light emission, and
a ratio of the shift period to each of the small periods is changed for each large period including a plurality of the medium periods.

17. The information processing device according to claim 16, wherein
the large period includes a first medium period and a second medium period as the medium period,
the information regarding the distance is intermediate data for calculating distance data, and
the another light source detection unit detects the noise on a basis of a comparison result between the intermediate data of the first medium period and the intermediate data of the second medium period.

18. The information processing device according to claim 16, further comprising
a transmission unit that transmits information regarding the another light source.

19. A distance measuring device comprising:
a light receiving unit that receives reflected light in which light emitted from a light emitting unit according to a light emission instruction issued on a basis of a predetermined processing cycle is reflected by a subject; and a calculation unit that calculates distance data to the subject according to a difference between a light emission timing of the light emitting unit and a light reception timing of the light receiving unit,
wherein the light emission instruction is issued at a timing delayed by a shift period with respect to a reference timing in each cycle of the predetermined processing cycle for each medium period including a plurality of small periods each including one time of light emission, and
a ratio of the shift period to each of the small periods is changed for each large period including a plurality of the medium periods.

20. An information processing method executed by an information processing device, the information processing method comprising:
for light that is emitted from a light emitting unit according to a light emission instruction issued on a basis of a predetermined processing cycle and in which information regarding a distance to a subject is calculated according to a difference between a light reception timing by the light receiving unit that receives reflected light obtained by the light being reflected by the subject and a light emission timing of the light emitting unit,
issuing the light emission instruction at a timing delayed by a shift period with respect to a reference timing in each cycle of the predetermined processing cycle for each medium period including a plurality of small periods each including one time of light emission; and
changing a ratio of the shift period to each of the small periods for each large period including a plurality of the medium periods.
